(19) United States
(12) Patent Application Publication
(10) Pub. No.: US 2014/0096437 A1
(43) Pub. Date: Apr. 10, 2014

(54) COMPOSITIONS AND METHODS FOR LEACH EXTRACTION OF MICROORGANISMS

(71) Applicants: Richard Crowell, Fort Collins, CO (US); Mark T. Machacek, Fort Collins, CO (US); Stephen Todd Bunch, Berthoud, CO (US); Dennis Gertenbach, Lakewood, CO (US)

(72) Inventors: Richard Crowell, Fort Collins, CO (US); Mark T. Machacek, Fort Collins, CO (US); Stephen Todd Bunch, Berthoud, CO (US); Dennis Gertenbach, Lakewood, CO (US)

(21) Appl. No.: 14/000,385

(22) PCT Filed: Feb. 16, 2012
(86) PCT No.: PCT/US12/25442

§ 371 Date: Dec. 20, 2013

Related U.S. Application Data
(60) Provisional application No. 61/443,336, filed on Feb. 16, 2011.

(51) Int. Cl. C11B 3/00; B02C 23/18; C10L 1/18

(52) U.S. Cl. CPC C11B 3/006; C10L 1/1802; B02C 23/18
USPC 44/307; 554/175; 252/182.12; 209/132; 241/17; 73/818; 206/525

(57) ABSTRACT

Embodiments herein concern compositions, methods and uses for extracting target compounds from suspension cultures. In certain embodiments, suspension cultures may comprise algal cultures. In some embodiments, compositions and methods include agglomerating ground and dried biomass from a suspension culture prior to extracting target compounds from the culture.

### CROSS-REFERENCE

This PCT Application claims priority to U.S. Provisional Application No. 61/443,336, filed Feb. 16, 2011. This application is incorporated herein in its entirety for all purposes.

### FIELD OF THE INVENTION

Embodiments of the present invention generally report methods and compositions for improved leaching of biomass harvested from microorganism cultures. In certain embodiments, compositions and methods concern agglomerating essentially dried biomass from suspension microorganisms using methods and devices reported herein. Other embodiments concern methods for agglomerating harvested and essentially dried microorganisms in preparation for processing or extracting target compounds generated by the microorganisms. Yet other embodiments concern systems and methods for leaching or extracting agglomerated cultures for increased recovery of biomass or target compounds from the microorganisms.

### BACKGROUND

Microorganisms can be used to produce many byproducts and products with potential uses as, but not limited to, fuels, biofuels, pharmaceuticals, nutraceuticals, small molecules, chemicals, nutritional supplements, feeds, feed stocks and food. To produce and isolate these products, cultures can be concentrated to an elevated cell density before being processed to recover desirable compounds. Further, extraction processes can be used to isolate or concentrate these products.

Efficiently utilizing microorganisms for the production of products can be challenging. For example, with respect to the production of algae biofuels, there are few cost-effective and efficient separation technologies available for extracting compounds from algae. There are several factors that contribute to the lack of efficient separation technologies. For example, handling of dry or semi-dry solid materials, including ground algae, can lead to segregation, as can be seen when material is stacked in a pile; the larger particles of the material rolls down the pile while finer-sized material remains near the top. In addition, the presence of unconsolidated fine and coarse materials can lead to segregation of particles during pneumatic or mechanical handling. If irrigated, fine particles among the unconsolidated range of particles can migrate and segregate within the mass, leading to percolation problems. The presence of fine particles can lead to localized preferential flow (channeling), blinding of areas to fluid flow (blinding or plugging), and pooling of liquid (flooding). This particle segregation can promote problems during extraction and/or processing.

### SUMMARY

Embodiments of the present invention generally report methods and compositions for biomass obtained from suspension cultures. In certain embodiments, compositions and methods concern improved leaching methods. Other embodiments concern compositions, methods and uses for extracting products and/or biomass from microorganisms. Some embodiments concern suspension compositions including, but not limited to, microorganisms such as algae, bacteria, yeast, fungi, and suspended solids in water and wastewater particulates. Yet other embodiments can concern systems and methods for efficiently separating biomass from a liquid or separating target compounds from biomass (e.g. algae) using agglomeration techniques.

Some embodiments of the present invention relate to extracting target compounds, such as biofuels, from biomass, such as microbial biomass. In accordance with these embodiments, a suspended culture (e.g., algae) is dried and milled, creating fines and other small particles. An agglomerated particle is created using those small particles. In some embodiments, the small particles retain much of their individual surface area. Target compounds are then extracted from the agglomerated particles through leaching techniques.

In other embodiments, dried and ground biomass from a suspension culture is agglomerated by rolling at least partially dried suspension cultures in an apparatus with a liquid, optionally, wherein the liquid is administered to the culture drop wise, and forming a clot or clump of biomass particles and thus agglomerating the biomass. The at least partially dried suspension cultures may be exposed to heat via air, light, microwave, visible light, infrared, other electromagnetic radiation or other energy source in order to further dehydrate the biomass or the suspension culture.

In some embodiments, ambient pressure is adjusted during drying after agglomeration in order to advance dehydration of the biomass.

Yet other embodiments report cultures that are used for processing and those cultures that have improved permeability when exposed to a reactive or non-reactive agent compared to non-agglomerated cultures.

Other embodiments report cultures that are exposed to a gas optionally, wherein the gas is a non-flammable gas, and wherein the agglomerated cultures form a non-flammable mixture with the gas.

In certain exemplary methods, the agglomerated cultures are further exposed to a solvent and products of the agglomerated cultures are extracted. In those embodiments, the rate of extraction of products of the agglomerated cultures is improved compared to extraction of products from non-agglomerated cultures.

In some embodiments, the temperature of post agglomeration drying at atmospheric pressure ranges from 32 degrees Fahrenheit (0 degrees Celsius) to 150 degrees Fahrenheit, but at a selected temperature that is below the temperature at which target compounds for extraction are degraded. The temperature may range from is 70 degrees Fahrenheit or greater but less than 150 degrees Fahrenheit when the pressure is atmospheric.

In certain embodiments, the pressure is less than atmospheric and the temperature is less than the temperature at atmospheric pressure in order to reduce risk of degrading target products of the cultures.

In other embodiments, the cultures are spray-dried.

In yet other embodiments, the suspension compositions include, but are not limited to algae, bacteria, yeast, fungi, and suspended solids in water, or wastewater particulates.

In some embodiments, a binding agent is used in agglomerating particles. The binding agent may include corn starch, alginates, glucose, sucrose, fructose or other sugars, lignins, polymeric binders, or carbohydrates. Some embodiments use insoluble binding agents. In other embodiments, water or aqueous suspensions of cultures can be used when agglomerating particles.

In certain examples, the ratio of liquid to culture may be a predetermined ratio.

Agglomerated cultures as disclosed herein can include particles that are 50 percent or 60 percent, or 70 percent or 80 percent or 90 percent or more are greater than 300 microns in diameter.

In some embodiments, agglomerating conditions are selected by strength and stability of agglomerated particles.

Other embodiments include a process for extracting one or more target compounds from biomass from a suspension culture, comprising applying an agglomerated suspension culture to a separation device and extracting a target compound from the agglomerated suspension culture. The separation device can be a column with a high aspect ratio, optionally with a height to width ratio greater than one, wherein solvent-to-solute efficiency increases with an increase in ratio.

Certain embodiments utilize an apparatus for agglomerating a suspension culture comprising a vessel capable of receiving water or other agent, the vessel capable of moving in at least one direction and a support attached to the vessel capable of moving from one location to another.

Some embodiments include a device for assessing compressive strength of an algal prill comprising an agglomerate test device, for example, as depicted in FIGS. 6A-6E having at least one retention screen layer and a drain wherein the device is capable of assessing compressive strength of the algal prill. In addition, tests contemplated herein may be conducted in the presence of one or more solvents for extraction of one or more target molecules in the algal material.

In other embodiments, a target compound is extracted from a biomass. The biomass can be dried and then milled to create fines. The fines can be agglomerated to create agglomerated particles. A solvent can then be percolated through the agglomerated particles to extract one or more target compounds.

In some embodiments, counter-current leach extraction techniques are used.

In certain embodiments, the biomass can be dried at a temperature between 95° C. and 120° C.

In other embodiments, ambient pressure is adjusted while agglomerating fines in order to advance dehydration of the biomass.

In some embodiments, the agglomerated particles are exposed to a temperature ranging from 85 degrees Fahrenheit up to 150 degrees Fahrenheit.

In certain embodiments, a first solvent is used to extract a first target compound, and a second solvent is used to extract a second target compound.

In other embodiments, agglomerating the fines to create agglomerated particles can include rotating the fines while applying a wetting solution (or an insoluble binding agent).

In yet other embodiments, solvent can be applied to the agglomerated particles at about 35° C. to exactly 35° C.

In certain embodiments, agglomerated particles are attached to a neutral substrate. Examples of a neutral substrate may include, but are not limited to, particles of plastic, stone, metal or other suitable material.

In certain embodiments, particles after grinding but before agglomeration can be 1500 microns or less in diameter, or 850 microns or less in diameter, or 300 microns or less in diameter.

In some embodiments, the fines of less than 300 microns can be removed prior to agglomeration. In other embodiments, agglomerated particles equal to or less than 300 microns can be further processed for target product extraction.

Other embodiments herein include agglomerated cultures wherein 50 percent, or 60 percent, or 70 percent, or 80 percent, or 90 percent, or more are greater than 300 microns in diameter.

In some embodiments, agglomerated particles can be created at a sub-atmospheric pressure.

### BRIEF DESCRIPTION OF THE DRAWINGS

FIG. 1 represents a plot of leach recovery of lipids from dried algae under various conditions of drying temperature and ground particle size, as a function of time.

FIG. 2 represents a plot of hexane leach recovery from dried algae as a function of particle size.

FIG. 3 represents an illustration of an exemplary agglomeration apparatus.

FIGS. 4A and 4B represent illustrations of other exemplary agglomeration apparati.

FIG. 5 represents an illustration of agglomerates formed after increasing addition of a liquid, expressed as a proportion of mass of liquid to dry mass of algae.

FIGS. 6A-6E illustrate exemplary devices of certain embodiments reported herein.

FIG. 7 represents a depiction of agglomerated algae wetted by solvent in a glass column.

FIG. 8 represents an exemplary plot of lipid mass yield from hexane leaching of columns of agglomerated particles of various bed heights, using various leachant application rates.

FIG. 9 represents exemplary gas chromatography analyses of fatty acids from extract from solvent leaching of dried and agglomerated algae under various conditions.

FIG. 10 represents leach extraction in a tall column at high solvent application rate for a short duration, followed by low application rate.

FIG. 11 represents data from FIG. 10 from the start of elution to 4.5 hours.

FIG. 12 represents gas chromatography analyses of hexane leach extract composited as a function of time.

FIG. 13 represents leach extraction in tall column tests at varying durations of high flow application rates.

FIG. 14 represents data from FIG. 13 displaying a detailed view of initial 12 hours of leach extraction in tall column tests, illustrating the effects of diminished solvent application rate on gravimetric yield.

FIG. 15 represents an exemplary gas chromatography analysis of total hexane leach extract from a column leaching test.

FIG. 16 represents an exemplary plot of primary and secondary leaching of dried and agglomerated algae at various column heights and irrigation rates.

FIG. 17 represents a photograph of a thin layer chromatography (TLC) plate from algal leach extracts from polar and non-polar solvents.

FIG. 18 illustrates some effects of liquid to solid ratio on agitated leaching of dried algae with solvent (e.g. hexane).

FIG. 19 represents gravimetric yield during secondary leaching of dried algae at varying bed heights and polar solvent application rates.

### DETAILED DESCRIPTION

In the following sections, various exemplary compositions and methods are described in order to detail various embodiments. It will be obvious to one skilled in the art that practicing the various embodiments does not require the employment of all or even some of the specific details outlined herein, but rather that concentrations, times and other specific details may be modified through routine experimentation. In some cases, well-known methods or components have not been included in the description.

As used herein “suspension cultures” can refer to cultures up to the time of harvesting.

As used herein “biomass” refers to suspension cultures where media has been essentially removed from the cultures (e.g., dried cultures). Biomass can be stored by any method for any period of time or used immediately for example, for extracting of target compounds.

As used herein “fluid” can mean a liquid or a gas. For example, solvent fluids can be a liquid and drying fluid can be a gas.

As used herein “agglomeration” can mean the clumping of dried and ground biomass from a suspension culture by certain embodiments described herein. In addition, “agglomeration” as used herein can concern attachment of fines of dried and ground biomass from a suspension culture to larger particles, creating larger particles from smaller ones, or attaching particles to other substances, such as a neutral substrate.

Some embodiments of the present invention are directed at extraction of target compounds from a biomass using agglomeration and/or leaching techniques that increase the flow of an extraction solvent through biomass which has been harvested from a culture of cells. In accordance with these embodiments, agglomerated biomass can be used in agitated, fluid-filled, or packed-bed leaching devices for increased extraction of target compounds at reduced cost and increased production. Target compounds can include, but are not limited to, a product, chemical compound, a biofuel, small molecules, nutritional supplements and feed stocks. Exemplary biomass materials can include, but are not limited to, algae, bacteria, yeast, fungi, suspended solids in water and wastewater particulates. While biomass derived from suspension cultures are used in several embodiments, other sources of biomass may also be used, such as a harvested biomass grown as a mat or a consolidated mass.

In some embodiments, the suspension culture can be algae cultures. The algae used in these embodiments can include stationary species, suspended, mobile species, or a combination. Examples of algae species can include, but are not limited to, Nannochloropsis spp. while other species include, but are not limited to, kelp, e.g. Saccharina spp. Any microbial culture is contemplated herein. For example, algae can produce a variety of compounds, including lipid compounds used in several industries. Lipids can be produced during various stages of the algal life cycle. Various species of algae have been grown and harvested for their lipid content, which are produced by the cells and principally located in cell walls and within the cell as storage products, among others. Cultured algae having compounds or products of interest can be collected and concentrated, or “dewatered,” prior to recovery of target compounds.

Targeted compounds can be extracted from cultured organisms (e.g. algae, bacteria etc.) using leach extraction techniques. During leach extraction, solvents can be used to free target molecules from the organisms. Non-polar components harvested from an algal culture, for example, can include, but are not limited to, triglycerides, diglycerides, monoglycerides, polyunsaturated fatty acids (PUFAs), and free fatty acids (FFAs) and other known molecules in the art. Polar components that can be harvested from, for example, algal cultures can include, but are not limited to, phospholipids, eicosapentaenoic acid (EPA), docosatetraenoic acid (adrenic acid), docosahexaenoic acid (DHA), docosapentaenoic acid (DPA), and eicosatetraenoic acid (arachidonic acid or ARA), and other polar molecules known in the art to be produced by algae. Alternatively or along with these extractions, some embodiments operate in the absence of one or more of the polar or non-polar target molecules (e.g., PUFAs). In accordance with these embodiments, target saturated fatty acids in the C16 and C18 range in an environment with low or incidental amounts of PUFAs (e.g., C20:4 and C20:5) can be produced and isolated by methods disclosed herein.

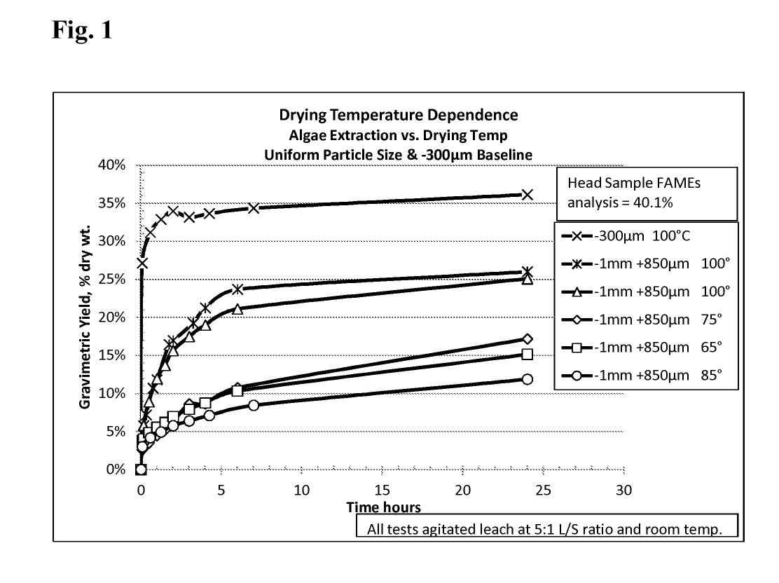

In certain embodiments, algae may be processed in aqueous solution, or dried for processing, with the partial or substantial absence of water. It has been demonstrated that drying of algae for recovery of lipids can be improved at certain temperatures for better recovery lipid components. In accordance with these embodiments, the algae may be dried at temperatures ranging from 85° C. to 100° C., or even at temperatures greater than 100° C. (e.g. about 112° C.). In one example, algae was dried at temperatures maintained in separate tests at 65, 75, 85, and 100 degrees Celsius (° C.) and the solidified mass was then crushed and ground. Selected size fractions (those passing a 1 mm sieve but retained by an 850 micron sieve, i.e. −1 mm +850 μm), were then agitation leached in hexane for comparison with cultures not maintained at these temperatures for drying and compared among the selected temperatures. One sample of algae dried at 100° C. but also containing a distribution of particles all sized smaller than 300 microns was also included. See, e.g., FIG. 1.

In certain embodiments, drying can be accomplished by application of incident light or other energy (e.g. microwaves,), by application of heat, or by passage of ambient air or heated air through or over the agglomerated material. Drying can be used to increase subsequent leach extraction. This can be accomplished by removing liquid from cell membranes to reduce dilution and increase penetration by solvents, thus allowing better solvent access to compounds of interest, thus increasing leach extraction using solvent-applications. Specific drying temperatures maintained or reached at peak level may be optimized for improved leach extraction of compounds. Algae dried at temperatures above 85° C., especially in the region of 100° to 112° C., were found to provide improved lipid extraction from for example, Nannochloropsis spp. in subsequent leaching. See, e.g. FIG. 1. Drying temperatures above that at which components contained in the biomass begin to break down are suboptimal, e.g. Nannochloropsis spp. dried at approximately 148° C. was blackened, exhibited a charred odor, and produced a hexane leach extract of nearly-black color (data not shown).

According to some embodiments, a biomass cake with a dry matter content ranging from about 1% -99% is dried until the cake has a dry matter content ranging from about 90%-100%. According to some embodiments, the biomass may be dried at a temperature at or above approximately 85° C., or at or above approximately 100° C. or higher. In accordance with these embodiments, the biomass may be dried above the pasteurization temperature, such that the biomass may be processed without pasteurization. According to some embodiments, processing the biomass may require cell disruption and/or permeation. In those embodiments, the cell permeation may be supplied by drying, which shrinks the membranes and removes oleophobic behavior and enables penetration by non-polar solvents. In addition, during the drying process (and/or the initial handling process), very small particles (e.g., “fines”) may be generated, which can aid in subsequent milling processes, as described below.

According to some embodiments, the culture (e.g., algae) is processed in a particular fashion to efficiently extract compounds of interest. For example, dried microorganisms (e.g., algae) are ground to form particles of smaller size, which enables better fluid contact with later solvents (e.g., leaching agents). In addition, if the biomass is highly dried, small particles (e.g., dust, flakes, or fines) may assist in milling the biomass, being already of sufficiently fine and desired size. Those smaller particles can then form composite (e.g, agglomerated) particles, as described in more detail below. At the same time, even when the smaller particles are agglomerated into larger particles, those smaller particles may still be readily identified (e.g., visually identified) within the agglomerated particles, demonstrating that the surface area of the smaller particle may be utilized for better solvent contact. See e.g. FIG. 20 Thus, an agglomerated particle, which is a composite of smaller particles, has greater surface area than, for example, a cylindrical particle formed through, for example, an extrusion process.

One aspect to this processing is the attachment of fine size fractions, also referred to as “fines,” to larger particles in a process referred to as agglomeration. The particles thus formed are known as “agglomerates” or “prills.” Agglomerates are aggregations of particles in which fine particles are fixed to larger particles and/or to each other. This fixation may be a semi-permanent attachment and is distinct from the flocculation or clumping of algal cells in aqueous suspension cultures under the influence of weak attraction forces. These flocculates (“floccs”), or large clumps of cells, are formed in aqueous suspension and are of little use in the dry processing of algae because the weak attractive forces do not survive the removal of water. Similarly, though dry fine particles may become electrostatically charged and temporarily be attracted to one another, this effect does not last when wetted with extraction solvents. To be useful for extractive processing of the algae, particle-to-particle attachment should remain prevalent and effective and prevent detachment and mobilization of the fine particles.

In certain embodiments, agglomeration of microorganisms can include using dried and crushed or ground biomass agitated by rolling in a vessel. Vessels contemplated of use herein can include, but are not limited to, a tube, barrel, drum, or rotating disk. In certain embodiments, a liquid can be applied to the suspension cultures drop-wise or another fashion. Some embodiments use discrete drops of liquid for localized wetting of particles that subsequently form a nucleus for the attachment of other particles.

In some embodiments, agglomeration can be accomplished using naturally occurring or endogenous constituents of algae which, when combined with water, are capable of attaching and binding particles. Thus, in those embodiments, only water is added to the algae when creating the agglomerated particles. In other embodiments, a suspension culture of cells in water may be added as the liquid to cause agglomeration of other, dried biomass, obviating the need for separation of the suspended cells from the water. When the liquid is added to the dried and ground biomass, the added water moisture achieves attachment of fine particles, and that additional moisture can be removed by drying prior to leaching. Other embodiments utilize binders that can be added to the material intended for packed bed extraction with the intent of forming agglomerates where the binding agent induces agglomeration or increases the rate of agglomeration or the like. Some binders contemplated of use herein include, but are not limited to, sugars, starches, corn starch, molasses, alginates, glucose, sucrose, fructose or other sugars, lignins, polymeric binders, or the like, or other known binding agents. In accordance with these embodiments, a binder should be insoluble in the leaching agent in order to achieve agglomeration or soluble depending on the conditions and target compounds being sought.

In some embodiments, particles after grinding but before agglomeration can be 4000 microns or less in diameter, or 850 microns or less in diameter, or 300 microns or less in diameter, etc. After agglomeration, particles can be 300 microns or more in diameter, or 500 microns or more in diameter, or 2000 to 5000 microns or more in diameter. Other embodiments herein include agglomerated cultures wherein 50 percent, or 60 percent, or 70 percent, or 80 percent, or 90 percent, or more are greater than 300 microns. Thus, the microorganisms may be milled, flaked, comminuted, etc., to small sizes that enable greater contact with solvents.

In some embodiments, the agglomerated culture is subjected to further processing. For example, the agglomerated culture may be dried (or further dried) by heat or air (or both) applied to the agglomerated culture, which can improve the robustness of the agglomerated particles (agglomerates) to physical and chemical contact and improve subsequent leach recovery of target compounds. Temperatures of post-agglomeration drying can be the same as for initial drying of the biomass: at atmospheric pressure the temperature can range from 32 degrees Fahrenheit (0 degrees Celsius) up to a temperature where desirable compounds in the algae are degraded. In accordance with these embodiments, in the case of atmospheric pressure drying of some species of algae, one drying temperature can be greater than 85 degrees Fahrenheit but less than 150 degrees Fahrenheit. Decreasing-from-ambient atmospheric pressures can lower a temperature at which drying occurs. This can be used to achieve essentially dry to completely dry agglomerates without incurring degradation of easy-to-degrade compounds, if desired.

Some embodiments concern spray drying of a solution containing algae to produce particles of predominantly dry algae to prepare them for optimized fixed bed leaching as described herein. Preparation of agglomerates by spray drying reduces the need to pre-dry and grind the algae. Additional spray drying or other agglomerating treatment, e.g. imparting rolling action, may be necessary to subsequently agglomerate the spray dried particles to create a desirable particle size with concomitantly larger pore sizes when placed into a packed bed. In other embodiments, agglomeration of algae can be achieved by spray drying of an algal solution and agglomerating the culture concurrently with water removal for subsequent optimized packed bed leaching. Spray drying techniques useful in these embodiments include temperature controlled drying in or out of the spray-drying air stream. In other embodiments, temperature variance utilized to dry algae may be used to optimize subsequent leaching extraction. Water used during agglomeration can be removed for example, by subsequent drying, once a desired attachment of fines is achieved.

Thus, in some embodiments, wet concentrated cells can be dried at a predetermined temperature appropriate for the suspension culture of interest as described above. Once dried, these cultures can be ground into a predetermined particle distribution sizes and agglomerated as described herein. Optionally, certain embodiments provide for re-drying at similar temperature ranges as initially determined after agglomeration, as necessary. It is contemplated herein that one or more drying steps may be used in order to achieve essentially dry agglomerate appropriate for extracting target compounds of a suspension culture.

In certain embodiments, agglomerated particles are placed in a bed for leaching by upward or downward flow of a solvent. Attachment of fine particles to other fine particles as well as to larger particles to increase effective average particle size can make the fine material more resistant to being carried out of the leaching bed by fluid flow. Accordingly, some embodiments use agglomeration techniques that achieve semi-permanent aggregation and agglomeration of particles to form larger particles and prevent mobilization and transport of finer particles within a packed bed sufficiently to maintain fluid flow through the packed bed. In this manner, those embodiments maintain a more uniform and permeable bed of particles and preclude segregation and migration of said particles during leaching, which can lead to preferential flow of solvent to some areas (i.e., “channeling”) and reduced flow to other areas (e.g., “plugging”). In addition, by maintaining relatively open interstitial spaces between particles (referred to as “pores”) throughout the bed of material (also referred to as a “packed bed”, “fixed bed”, or simply “bed”), a solvent can be applied evenly throughout the packed bed, which can increase recovery of extractable compounds. In some embodiments, biomass particles (e.g., fines) may be agglomerated with a non-reactive solid, such as a neutral substrate. The non-reactive solid acts as a structure to maintain a packed bed structure during a subsequent leaching process.

Some embodiments concern using fixed-bed leaching. Using a fixed bed leaching configuration allows well-differentiated sequential leaching. Following extraction using a first solvent to extract a compound, the column can be dried if desired with a gas stream then a second solvent can be applied which extracts predominantly different compounds from the first solvent. These processes can avoid contamination of one leachant with another or mixing of leachants which can affect processing of target compounds. In certain embodiments, agglomerated algae in fixed bed leaching permits ease of changeover from one solvent to a different solvent. In accordance with these embodiments, hexane can be followed by ethanol (non-polar or polar solvents can be used), which can permit simplified segregation of compounds. This separation of solvents may avoid costly post-processing separation of otherwise mixed solvents and leached compounds. In some embodiments, multiple solvents are selected so that they can be mixed together and applied simultaneously.

Following the application of the last of a second (or a third, a fourth, etc.) solvent, the bed can be purged of solvent and, optionally, dried again prior to unloading. It is contemplated herein that solvents can be mixed, for example two or more solvents can be mixed and used in any extraction process described herein (e.g., hexane and ethanol, methanol, chloroform, etc.). Thus, by treatment in a permeable packed bed, various solvents of preferred chemical character, e.g. polar and non-polar, can be applied sequentially to extract different compounds of interest from the sample mass, also known as the “charge.” This sequential application of solvent types permits the separate recovery and segregation of extracted products. This segregation can be desirable for reduction of later costs of purification and separation of one compound from another. Sequential leaching may also provide the opportunity to produce a more pure product, target compound, or biofuel extract. In certain embodiments, unwanted compounds can be eluted or removed from an agglomerated culture prior to target compound leaching.

In some embodiments, the solvent is used in a percolation system in which the solvent soaks through aggregated particles, rather than a system in which solvent is used to cover biomass particles. Using a percolation system allows the solvent to dissolve solute as it passes through the aggregated particle (e.g., around the smaller particles that make up the aggregated particle). The aggregated particle may be oriented in an upright position with the solvent introduced at the top of the aggregated particle so that gravity may pull the solvent through the aggregated particle and out through its base (e.g., bottom). In these embodiments, the solvent may be used only once (e.g.., without a need for recirculation), which decreases the amount of time and solvent needed. In other embodiments, the solvent may be circulated through the bed to increase the concentration of extracted compounds, for example to attain a desired concentration of solute or to reduce the amount of solvent-and-solute to be processed for separation. In some embodiments, the leach time may be approximately 24 hours or less.

In accordance with some embodiments, agglomeration can improve fluid flow, both of solvents and other fluids, through a packed bed. Improved fluid flow within a bed of agglomerated particles can improve solvent extraction (leach recovery), increase yields and increase efficiency of recovery of desirable components from the material in the packed bed. Improved fluid flow through a packed bed of agglomerated particles can increase the extent and rate of extraction from leaching operations. Agglomeration improvements of percolation and bed porosity can increase safety during leaching and other handling of potentially flammable solvents, for example, by purging or drying of the sample after leaching. Also, safety can be improved through the ability to flood the fixed bed pores with gases which create a non-flammable mixture with flammable solvents. Non-flammable fluids contemplated of use herein include, but are not limited to, nitrogen or carbon dioxide. Flammable solvents of use contemplated herein include, but are not limited to, hexane and ethanol.

Use of agglomerated algae particles in agitated leach configuration can improve filterability of particles after leaching. By improving filterability, more leaching agent and target compounds can be recovered. Further, by providing improved percolation and draining characteristics, agglomeration reduces the amount of leachant and/or rinsing agent left in solids in either filtered material or packed beds. In addition, the algae may be treated both before and during leach extraction to improve said recovery of the targeted compounds. Those treatments include maintaining the temperature during algae drying, maintaining the particle size of the algae solids subjected to leaching, maintaining the liquid-to-solid (“L/S”) mass ratio during leaching, and maintaining the temperature of the solvent, or “leachant.” Some of those treatments are described in more detail below.

Other embodiments concern varying ratios of solvent to solid mass in order to optimize extraction of products from biomass. In some embodiments, optimum combination or range of liquid-to-solid (L/S) ratio(s) can be determined by leach testing at various L/S ratios. Use of an optimum L/S ratio condition can minimize energy-intensive distillation of excess solvent from extracted compounds in the leachate, yet ensures solvent is present to achieve adequate recovery of the desirable compounds during leaching in either packed bed or agitated leach configuration.

Some embodiments presented herein concern leaching in a fixed bed configuration using a high length-to-diameter ratio. High aspect ratio can be greater than 1 length-to-diameter, or 5, or 10, or more. This can optimize leaching by minimizing the amount of leachant while optimizing the amount of solute in exiting leachate, and by countercurrent contact minimizing the resistance of solute extraction from equilibrium concentrations of solute in solvent and substrate. In other embodiments, leaching as disclosed herein can be achieved in a high aspect containment vessel, and potentially include leaching by both primary and secondary leachants, that is, extracting desirable compounds with one leaching agent, following by leach extraction with a second agent. The primary and secondary leaching agents may differ by general chemical classification, e.g., polar and non-polar solvents, or by specificity or strength, e.g., ethanol and chloroform.

Certain embodiments concern varying temperatures during leaching for improving extraction of desirable compounds. Increased temperature relative to room temperature, ambient temperature or air temperature (e.g. when operating outside or in an unheated area) can improve fluidity of solvents and extractable compounds, and increase chemical activity of solvents in the dissolution of solutes, and can be used to improve leaching of compounds from biomass. In some embodiments, the temperature used during the leaching process (and other processes) may be approximately 35° C., or may be less than 35° C. That temperature may be held steady or may vary. In some embodiments, maintenance of a desirable temperature during leaching may be used to inhibit or reduce the extraction of certain less-desirable constituents which are more soluble at other temperatures. In still other embodiments, one temperature range may be maintained for a one portion of a leach cycle, and altered to a different temperature range for another portion of a leach cycle.

Other embodiments concern leaching of agglomerated particles conducted in agitation, percolation or flooded bed configuration. In accordance with these embodiments, percolation leaching can provide an environment for counter-current leaching conditions, without the energy expenditure of mechanically suspending the biomass in the solvent. Agitation leaching is capable of extracting easily- and rapidly-leached compounds in a short period. Flooded leaching does not require continuous energy introduction to the leaching system, but can need multiple steps to achieve counter-current contact. Thus, various site or process constraints may favor application of one, or a combination of, of these leaching configurations over another, but under various conditions any of these methods may be more desirable for practice of leaching using agglomerated biomass.

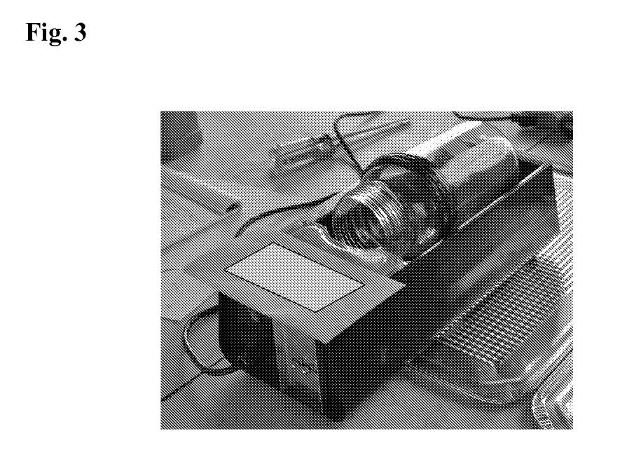

Certain embodiments concern determining relative strength and stability of agglomerates to optimize agglomeration conditions. A submersion test using prills in the relevant solvent is able to demonstrate durability of the agglomerate when saturated with solvent. A strength test using dried agglomerates placed in a compression device, with or without the presence of solvent, may be used to demonstrate mechanical integrity and durability during handling and leaching. For example, FIG. 3 illustrates an exemplary device for assessing compressive strength and other parameters of prills (e.g., algae prills) or for simulating the weight of agglomerates in a column. A compression mass is placed on a follower plate, which serves to compress the agglomerates within the cylindrical walls of a test column. The mass value of the compression mass illustrated may be selected to represent a certain mass of suspension culture (e.g., algae) and/or other components that would normally cause a pressure increase toward the bottom of the column or other vessel due to gravity. Instead of building a taller column to test the pressure and other characteristics at the bottom of the column, a shorter test column may be used with the compression mass to replicate the pressure force toward the bottom of the column that would normally result from the increased depth of a higher column. Different compression mass values may be used to replicate columns of different depths or heights. In addition, these devices can include a drain as illustrated and can be adapted for solvent use. Some devices contain multiple layer retention screens (e.g., aluminum) to support agglomerates. Resilience of agglomerates can be tested using this device.

In certain embodiments, kits are contemplated herein. For example, a kit can include, but is not limited to prill compositions housed in a container of use for future extraction of targeted products. A prill in a kit can include agglomerated particles where the majority, greater than 50 percent of the prill includes agglomerated particles of 300 microns or greater. In other embodiments, kits can be stored at a variety of temperatures in order to optimize shelf-life of the prill depending on the microbial biomass used. In certain embodiments, a kit may be kept at room temperature. In other embodiments, a kit may be kept in a refrigerator or a freezer or even stored in liquid nitrogen.

Any containers of use to optimally contain the components of a kit are contemplated herein.

### EXAMPLES

Below are presented several examples illustrating various embodiments, and combination of embodiments, disclosed herein. It is understood by one skilled in the art that certain parameters are exemplary parameters and these parameters may vary depending on conditions and other factors.

### Example 1

FIG. 1 represents a demonstration of leach recovery of lipids from dried algae, as a function of drying temperature and particle size. As illustrated in FIG. 1, when leached in comparable agitated environments, a −1 mm +850 micron size fraction sample dried at 100° C. achieved a significantly higher extraction of lipids on a mass basis compared to the other same-size fractions, and a 300 micron sample containing a distribution of significantly smaller particles obtained the highest extraction. It has been demonstrated that elevated temperatures can at some point result in degradation of lipid components of algae, the level at which this occurs during drying has not been fully established. While a temperature has been identified at which the composition of the algal lipids can be altered, this temperature has been shown to be greater than 112° C. Since algal mass, e.g. as filtration or centrifuge solids or “cake”, dries thoroughly and reasonably quickly at 100° C., this provides a parameter for which extraction can occur without risk of altering the algal lipids. Subsequent testing, using Nannochloropsis salina algae dried at sustained temperatures of 112° C. and then leached in agitated bottle roll and column tests, demonstrated that drying at up to 112° C. did not diminish recovery or demonstrate any damage to contained lipids.

When dewatered algae, e.g., algal culture filter cake or centrifuge-collected solids, is fully dried the 2-10 micron-sized cells comprising the algal matter form a solidified and hardened mass which is friable. Leaching the dried algae as a consolidated mass can result in low extraction recovery of the compounds of interest, due in part to extended diffusion flow paths for the solvent to reach cellular compartments and for the extracted compounds of interest to diffuse out of the consolidated mass and away from the algal mass into the bulk solvent solution. In addition, the surface area of a consolidated mass is very low, on a unit basis, e.g. cm²/g. To minimize extraction time and improve leach recovery, the dried algae can be subjected to particle size reduction by breaking, crushing and grinding. It was demonstrated that subsequent leach recovery can be improved at certain dried algae particle sizes. For example, smaller particles of dried algae generally leach faster than larger particles.

### Example 2

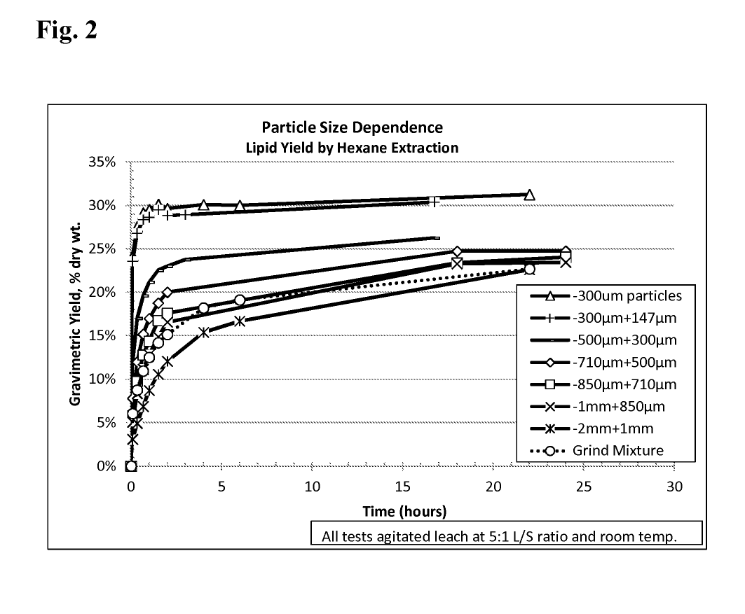

In one exemplary method, algal cultures were dried at 100 degrees Celsius, and the consolidated mass finely crushed. The sample was then screened, or “sieved”, to separate algae particles into several size classifications. Sub-samples of each size range were then subjected to agitated leaching in hexane in parallel tests to determine the rate and extent of leach recovery on a mass basis. One sample leached in parallel with the narrow size classification samples consisted of finely crushed material which was not sieved, representing the “grind mixture”. Conditions for leaching in this example were 5-to-1 L/S mass ratio at room temperature. Some of the results of these leaching tests are illustrated in FIG. 2.

FIG. 2 represents a plot of hexane leach recovery from dried algae as a function of particle size. It was demonstrated that particles occurring in larger size fractions (e.g. −1 mm +850 μm) were less accessible to hexane extraction of lipids compared to smaller size fractions (e.g., −300+147 μm). Further, leach recovery in these tests did not improve significantly with successive size fractions crushed finer than −300+147 microns. Therefore, as illustrated herein, smaller particles of dried algae leach more efficiently than larger particles, when leached under similar conditions, and achieve a greater extent of leaching recovery of desirable compounds. In certain embodiments, when conducted in an agitated process environment, these fines present minimal setbacks during leaching, though liquid-solid separation subsequent to leaching becomes progressively more problematic with finer particle size.

In other exemplary methods, it has been demonstrated that there are difficulties which frequently arise when attempting to pass fluids through settled or packed beds of finely crushed material. In these methods, presence of fines can lead to migration of the fines or minimization of pores representing fluid flow channels for extraction in the packed bed. Flow of fluids is negatively affected by these fines. Fines can significantly decrease flow channel size and reduce recovery of compounds of interest. Migration of fines or reduced size of pores in a packed bed can lead to preferential flow of solvent to some areas, “channeling”, and reduced flow to others, “blinding”, or obstruction of essentially all flow, “plugging”. These flow problems inhibit liquid-solid contact and can reduce or even prevent component extraction, bed rinsing, or drying, in that solvent can become trapped and be retained in areas of the packed bed. In one example of non-agglomerated leaching of dried solids (see Example 1), a charge of crushed and ground algae which contained approximately 20% mass smaller than 300 microns, was placed in as-produced form in a column 3″ (76 mm) dia. by 20″ (510 mm) tall. When solvent was applied to the top of the column, the column was soon unable to pass solvent through the bed in useful amounts, and the column had become effectively plugged. Even subsequent application of pressurized nitrogen gas at 10 psig (22 psia or 152 kPa) to the top of the column was unable to force useful amounts of solvent through the packed bed and the test was terminated. Subsequently, screening a crushed and ground algal charge to remove substantially all particles sized less than 300 microns was able to produce a permeable fixed bed for hexane extraction of lipids, but at added cost of processing and with the concurrent loss from the process of approximately 20% of the sample mass.

In certain exemplary methods, it is possible to create larger particles and thus reduce or remove fines less than 300 microns in order to create or maintain spaces (pores) between particles in the bed to reduce or eliminate the adverse flow effects of small particles and fines. In certain methods, agglomeration can be used where smaller particles are attached to larger particles or to one another to produce larger, compound particles. When fines are attached, they are no longer available for transport or migration, the effective average particle size is increased, and pore size within the packed bed likewise is increased. Larger pores and an increased number of pores can provide less resistance to fluid flow. When agglomerated material is subjected to leaching, solvent can be applied more evenly throughout the bed, at higher flow rates, leading to faster and greater recovery of extractable compounds.

In certain methods, agglomeration can be achieved by particle-to-particle contact in the presence of for example a supplementary compound, referred to as a “binder”, which causes the particles to stick to one another. A binder can be either an additive or a prior constituent of the charge. Frequently, the binder is activated by the addition of a liquid, though other reactive substances might be used. In some embodiments, agglomeration is accomplished by inducing a rotational motion of the particles, contacting them with one another. In one example, agglomeration of suspension cultures can be achieved in a vessel having dried and crushed cultures by rotating the vessel in such a manner as to cause the particles to cascade and roll past one another inside the vessel. Certain methods can include a binding agent to assist in agglomerating finer particles to larger particles and to each other. In certain methods a liquid can be added as coarse or large droplets, as opposed to a mist. Coarse droplets can provide a nucleus with moist surface area to assist particle agglomeration. Liquid can be added intermittently or continuously until sufficient particle attachment is achieved. In certain dried suspension cultures, sufficient natural materials have been shown to be present to effect agglomeration with the addition of water, without adding exogenous binding agents. This can reduce costs while increasing production from these cultures. Thus for example, promoting self-agglomeration (e.g. with certain algal species) with using course water applications only can be a significant cost saver, as well as a contributing factor to the purity of products produced. In these exemplary processes there would be no need to remove the added binding agent from a compound or product harvested from the suspension cultures.

### Example 3

In one method, a 1 L vessel was equipped with a spacer (shim), to elevate one end of the jar to contain dried and ground algae as the jar was rolled in horizontal position on a small rock tumbler. As the jar rolled, water was added with a spray bottle as the algae cascaded. FIG. 3 illustrates algae being agglomerated with this set-up. FIG. 3 represents agglomeration of dried and ground algae using a rock tumbler technique in a 1 liter vessel.

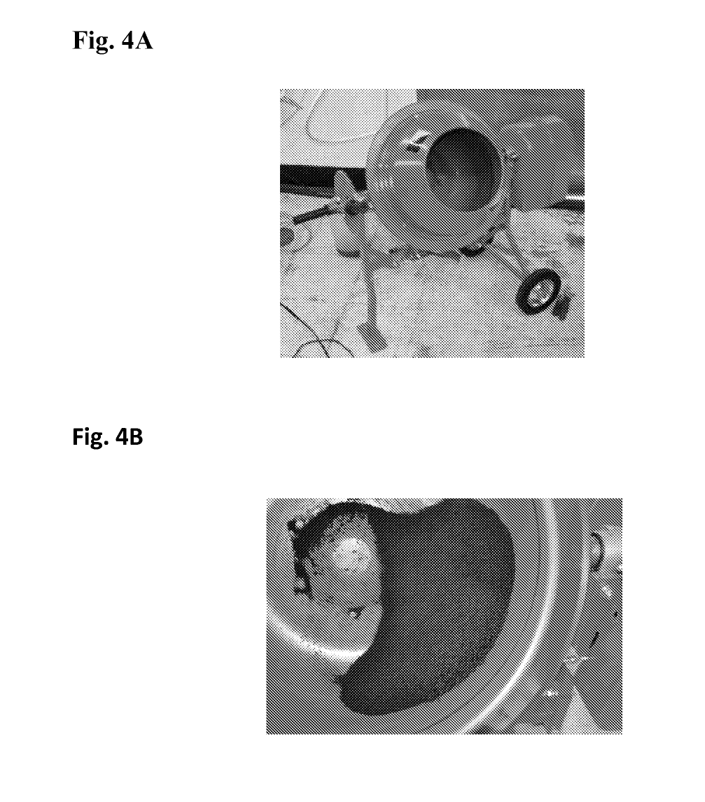

For agglomeration of larger samples, a 1.25 cubic foot (42 L) capacity electric cement mixer was used. FIGS. 4A and 4B represent a larger set up. FIGS. 4A and 4B represent a larger mixer (e.g. cement sized) used for agglomeration of larger volumes of algae cultures. FIG. 4A represents an electric mixer and FIG. 4B represents algae in the larger mixer, note the cascading action of the algae particles within the mixer. In addition, for larger samples, other mixers can be used (e.g. one-half a cubic yard; data not shown).

### Example 4

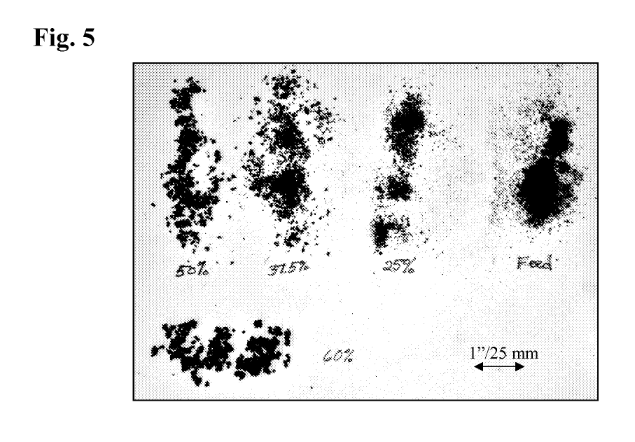

In certain methods, with the addition of exogenous liquids, additional drying may be needed to achieve target agglomeration of a culture. Re-drying a culture can lead to improved leaching response in the culture. Once agglomerates are formed, application of drying via heat, air, chemical or a combination can improve robustness or resistance of agglomerated particles (agglomerates) to physical and chemical contact. Re-drying can also removed resistance of the biomass cells comprising the sample to solvent interaction with components in the cells. For example, agglomerated material can be placed in a drying oven for a period, to reduce or remove fluid from the agglomerates. Drying and leaching tests conducted herein have demonstrated that leaching efficiency improved with successive increases in temperature, within the preferred range tested, but temperatures above which biomass compounds begin to degrade should be avoided. Consequently, re-drying of the agglomerated charge was carried out at the same optimal temperature used during the initial sample drying without agglomeration. FIG. 5 illustrates agglomerates formed from dried and ground algae, using various levels of water during agglomeration, noted by percent water added compared to dry mass algae (e.g. 100 g water added to 400 g dry algae=25%). One observation was that the size of the agglomerated particles increased as more water was provided during the agglomeration process. FIG. 5 represents effects of increasing water addition during the agglomeration process described herein.

The stability and strength of the biomass agglomerates can be tested after re-drying in a selected solvent using a submersion test. Several prills can be selected from the agglomerated charge of test material after re-drying, such that they represent a majority of the agglomerates and not the extremes, for example, too large or too small. The selected prills can be placed in a sealable vessel containing sufficient solvent to cover the prills, and observed in static condition over time for mechanical breakage or fines detachment. In some embodiments, the prills are capable of withstanding submersion for several days without significant deterioration. In an exemplary test, agglomerated algae particles remained in agglomerated form after seven days of submersion.

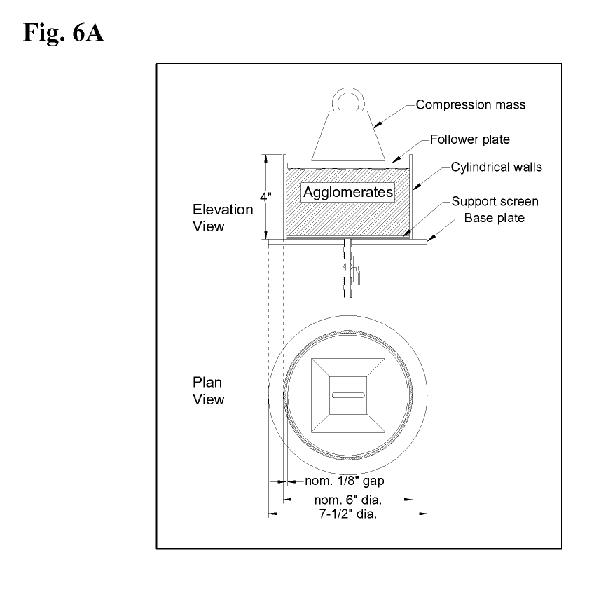

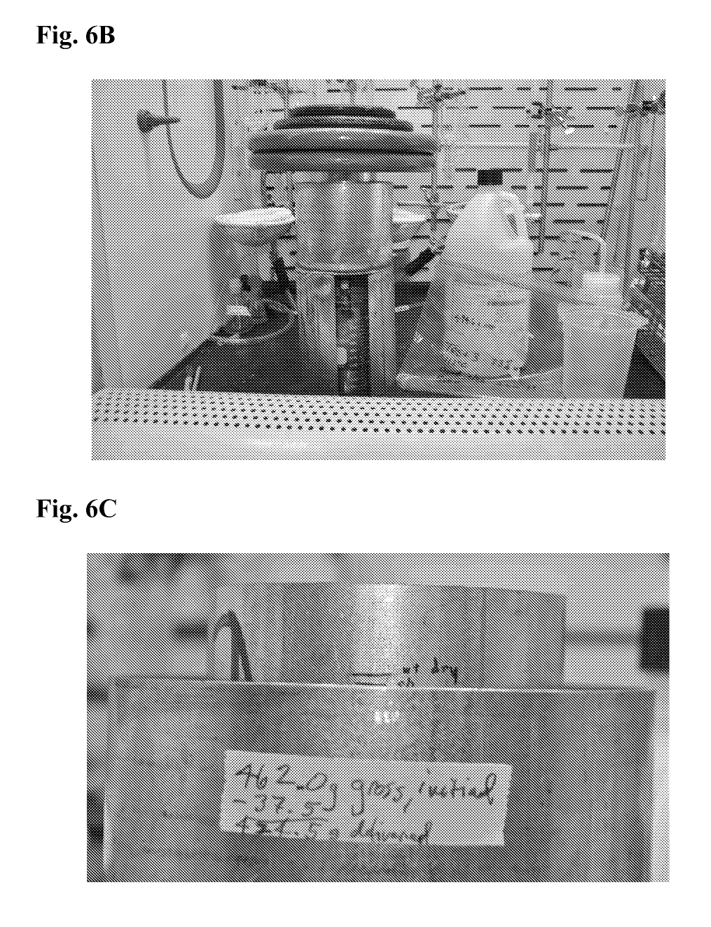

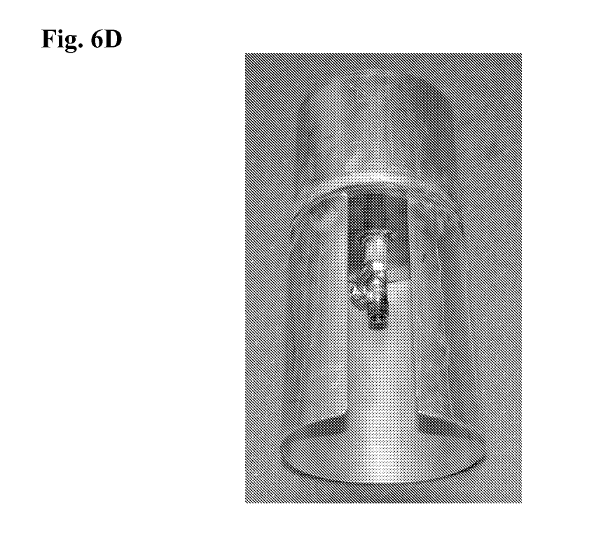

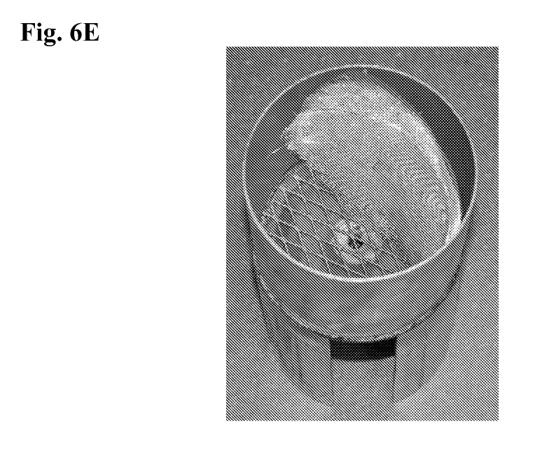

A testing device can be constructed to contain a sample of agglomerates and exert a known force per unit area to determine the ability of the agglomerates to withstand applied pressure. This test can be used to evaluate prill performance, and to provide confidence that well-formed prills under leach conditions are less likely or unlikely to collapse under the weight created by conditions for extraction. In one embodiment of the present invention, a device was constructed using a piece of 6″ (150 mm) diameter steel ventilation pipe, 6″ (150 mm) tall to contain the sample of interest, equipped with a seal-welded bulkhead floor, forming a cylinder closed at one end and open at the other. The bulkhead was slightly dished to aid drainage, with a hole drilled and tapped in the center of the plate and equipped with a ball valve for controlling the drainage flow. A stand was added, sufficient to straddle a beaker placed under the discharge valve. See e.g. FIG. 6D

Expanded mesh was placed on top of the bulkhead to aid drainage and to support a retaining screen to contain the agglomerated charge. The retaining screen was constructed from four layers of aluminum window screen. In this example, aluminum was selected but any material compatible with hexane or other desired algal lipid solvents, as known by one skilled in the art, could be used. See FIG. 6E. A top follower plate was fabricated of steel plate and cut to a diameter which provides ⅛″ (3 mm) clearance on all sides to the internal diameter of the cylindrical section. Weights can be placed on the follower plate to exert force on the agglomerates contained within the testing device. Depending on the physical proportions of the testing device and the sample mass utilized, an additional spacer or riser can be added to the follower plate. This spacer can be located between the added weights and the follower plate, for example, to prevent the weights from resting directly on the sample containment cylinder, rather than pressing on the follower plate as designed. As an example, the top plate can utilize a section of lightweight steel pipe, e.g. 4″ (100 mm) diameter by 4″ (100 mm) in length, tack-welded concentrically to the follower plate, as a spacer and support for weights. Any chemically compatible material known in the art can be used to compile any of the components of this apparatus, depending on need and solvent/extraction media used. FIG. 6A illustrates a schematic of the unit, in a configuration not requiring a spacer for the bearing weight. Support legs for the unit are not shown, for simplicity and clarity of the diagram. FIG. 6A represents an agglomerate crush strength testing device.

In operation of the apparatus describe above, a charge of agglomerate prills is loaded into the cylindrical section of the testing device. In certain methods, the charge should fill the unit sufficiently to keep weights resting on the spacer section from contacting the top of the cylindrical section, e.g. sample amounts in excess of 400 grams each were used in tests of agglomerated algae with the device constructed as described above. The charge is smoothed roughly level and the top bulkhead is set onto the charge. A location mark was drawn on the side of the spacer piece, level with the top of the lower cylindrical section of the device, using a straight edge if desired to aid in proper location of the mark. Weights are then placed on the spacer, to simulate conditions experienced in the leach bed. For example, as a boundary condition one could choose the pressure exerted on the bottom-most prills, assuming frictionless sides on a columnar leach vessel, e.g., to simulate a 10 ft (3 m) tall bed of agglomerated algae at a bulk density of 0.5 kg/L, approximately 62 lbs (28 kg) would be added. In reality, the sides of a leach column vessel assist in supporting the column charge, but a ‘frictionless sides’ scenario can be taken as an extreme condition, an example of a worst case boundary condition. Once weights have been added to the spacer on the dry charge, a second mark is added to the spacer to record the dry compression level. See FIG. 6B. The weights are then removed, and a “spring-back” mark may be added to demonstrate the resilience of the prills. See FIG. 6C. The weight and follower plate are temporarily removed and an algal lipid solvent, e.g., hexane, can be poured over the charge until liquid is visible across the entire surface of the charge. In this example, the volume of liquid added at this point represents the total of the hexane absorbed into the algae particles plus the pore volume of the test charge when compressed dry. The follower plate/spacer piece is replaced on the charge, and weights are once again placed onto the spacer. A “wet” compression level is then marked on the side of the spacer, level with the top of the cylindrical section. The apparatus can be left in this state for as long as desired, to simulate conditions the agglomerates will likely experience in for example, a column. In one test with the described device, after one hour no change in hexane-wetted compression level had occurred. After the desired length of time, the weights can be removed. The drain valve is opened to remove the solvent from the bed. If desired, the level of solvent can be lowered until the top of the compressed bed is exposed, the solvent receiving vessel emptied, and then the remainder of the solvent drained and captured. A second volume of complete drainage then represents the compressed bed pore volume. In one test of agglomerated algae, the pore volume measured was 51% based on compressed bed volume (the condition at which the hexane was originally added).

Extraction Examples:

After agglomeration and re-drying, the charge is ready for loading into an extraction device and is added to a container to form a fixed bed. The shape of such a container can affect the extent of leach extraction in the process. If leachant is added to a container with algal charge until the solvent covers the bed creating a static bath, leaching of solute will progress until equilibrium is established between the concentration of solute in the particles and the concentration of solute in solution. The solvent with constituents dissolved from the charge, collectively known as “leachate”, can then be drained from the bed and replaced, until the fresh solvent too achieves equilibrium solute concentration, and the process repeated. In such a process scenario, the shape of the charge container does not affect the extent of leaching. However, if the leach charge container is elongated vertically and solvent applied at the top to percolate through the bed and freely drain from the charge, the effect is to increase the differential concentration of solute in the leachate as it percolates through the charge. For example, fresh leachant applied to the top of the charge has maximum concentration differential compared to the solute concentration of the charge, and extraction proceeds. If the leachant percolates through a long flow path of algal charge, the dissolved solute concentration in the leachant successively increases and may reach equilibrium with the charge prior to exiting the column. This represents maximum utilization of each increment of leachant applied. Such a process scheme, where the solvent with least concentration of solute contacts the solid with least concentration of solute and solvent with higher concentration of solute contacts solid with higher concentration of solute, is known as counter-current contact. Counter-current contact results in a higher concentration extract and higher recovery of soluble constituents from the solids. For these conditions, an increased aspect ratio should be considered, for example a high length-to-diameter ratio, for an improved leachant process by creating counter-current leach conditions. Therefore, a columnar container for a suspension culture such as an algal culture leach extraction can be a high efficiency packed bed configuration.

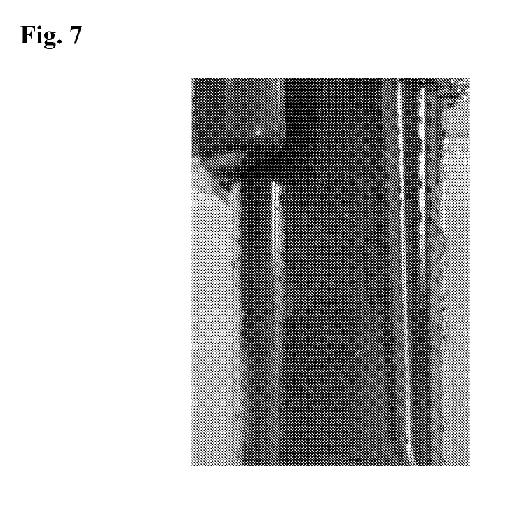

In another method, as the culture leach charge is loaded into the vessel, the vessel may be mechanically vibrated or manually struck to help settle the loaded material into place. Although such settling may be undesirable in the absence of agglomeration due to the restriction of pores and therefore flow paths through the bed, with agglomerated particles this can be used during loading to form a uniformly packed bed for leaching. Once loaded into the leaching vessel, the volume and mass of the charge can be recorded to calculate the settled bulk density, e.g. as pounds per cubic feet or kilograms per cubic meter. If desired, charges of similar character can be settled during loading to a uniform bulk density, assisting in creation of uniform bed conditions, especially helpful during process development. Once the culture charge is loaded into the leach vessel, the charge can be irrigated with a solvent suitable for extractions of target compounds, e.g. a polar solvent for recovery of polar compounds contained in the charge, or a non-polar solvent for recovery of predominantly non-polar compounds in the charge. In certain methods, the leachant should be applied within a certain range of application rates, to avoid exceeding the ability of the charge to accept and pass solution, known as “flooding”, or avoid a needlessly low solution application rate which achieves equilibrium with the charge soon after application, achieving only a relatively low leach recovery rate of solute and unnecessarily extending the leach duration. FIG. 7 illustrates an agglomerated algae loaded into a glass column and under leach by a solvent. FIG. 7 represents agglomerated algae wetted by solvent in a glass 2″ (50 mm) diameter column.

When a column leach is initiated with a fresh sample charge, a surplus of solute can exist more than the amount that the solvent can dissolve and extract. At this stage of the extraction process, a relatively high application rate can be applied to the charge to achieve a high rate of solute extraction. Separation of soluble components from the solvent, e.g. by distillation, is an energy-intensive process, and it is therefore desirable to minimize unnecessary dilution of soluble components with excessive solvent. Later in the leach process, for example, when the leachate exiting the leach column contains less-than-equilibrium concentration of solute, the solution application rate can be decreased to avoid more-than-necessary usage of fresh or recycled hexane applied to the column. Accordingly, the leachant application rate can be optimized for the stage of leaching or for other reasons, e.g., a certain deemed-desirable concentration of solute in leachate.

### Example 5

In the leaching of algal lipids from dried algae, it has been observed that a small amount of solvent wetting the algae for the first time leaches lipids from the mass in a concentration which can become very viscous. Leach tests, conducted at various flow rates and length of leach path, have confirmed it is possible to seal off portions of the particles from the solvent, reducing the leach recovery. An expression was developed for this effect, “tarring”. The following test work demonstrates this effect.

Six glass columns were erected to conduct leaching tests. All were 2″ (50 mm) diameter by 22″ (550 mm) tall. Two columns were arranged so that the discharge of one dripped directly into the other column, creating the equivalent of a fixed bed 44″ (1.1 m) tall, referred to as Column 1 Columns 2 through 5 were “single” height columns, operated independently from each other. All columns were loaded with algae using portions of a composite sample which had been dried, finely crushed and agglomerated as described previously, at 60% added moisture with a re-drying step at original drying temperature. Table 1 below represents various test conditions for these columns.

TABLE 1
Test Conditions for 2″ (50 mm) Diameter Leach Columns

| Test No. | 1 | 2 | 3 | 4 | 5 |
|---|---|---|---|---|---|
| Irrigation mode | High | High | Med | Low | High |
| Bed Height, mode | High | Low | Low | Low | Low |
| Bed Height, m | 1.12 | 0.56 | 0.56 | 0.56 | 0.56 |
| Actual bulk density, | 472 | 511 | 459 | 505 | 482 |
| kg/m³ | | | | | |
| Leach mode | Hex- | Hex- | Hex- | Hex- | Eth- |
| | Eth | Eth | Eth | Eth | Hex |
| Irrigation, ml/min | 2.1 | 2.1 | 0.93 | 0.38 | 2.2 |
| Irrigation, L/hr | 0.1 | 0.1 | 0.06 | 0.0228 | 0.132 |
| Effluent, L/d | 3.0 | 3.0 | 1.3 | 0.55 | 3.2 |

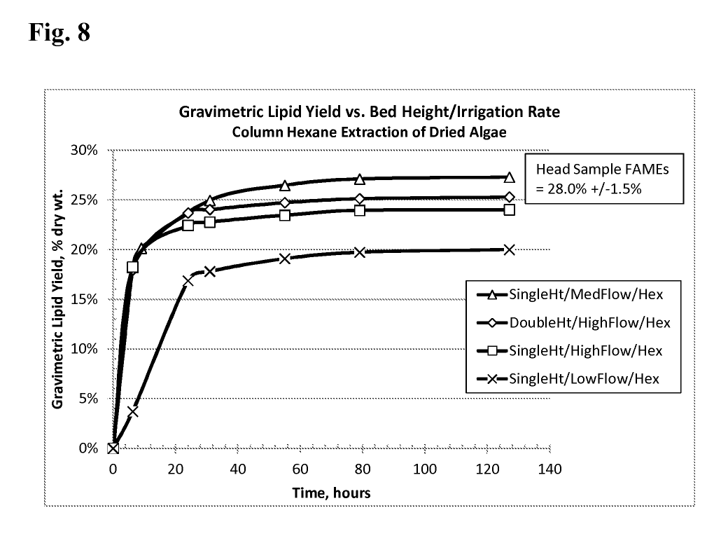

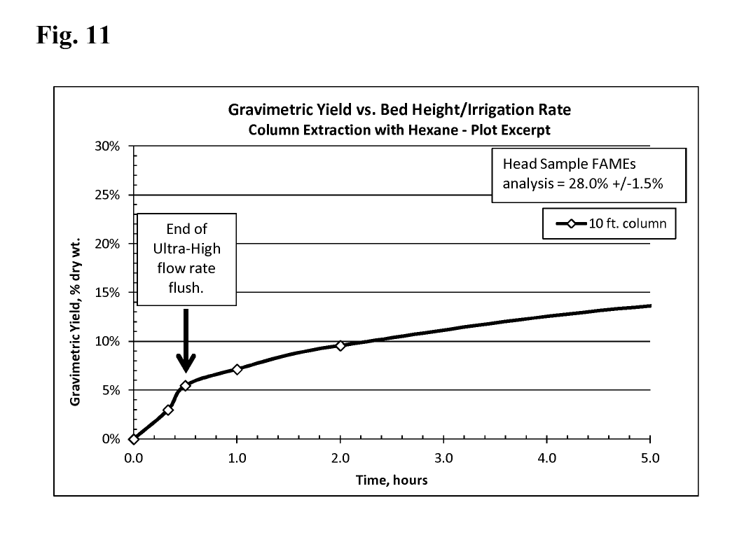

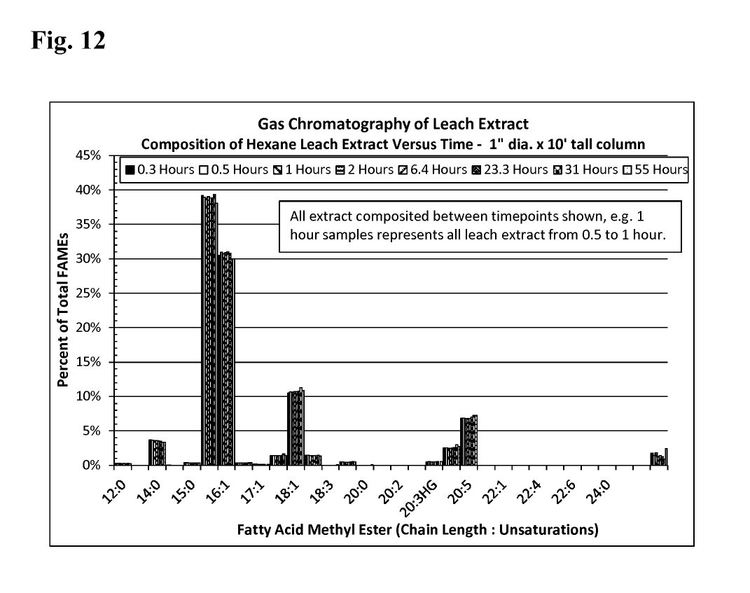

As noted in Table 1, the leach mode is noted as Hex-Eth or Eth-Hex, indicating the order in which leachants were added to the columns test, e.g. Hex-Eth indicates that hexane was used to conduct extractive leaching, which was followed by drying, and then ethanol was used as a secondary leachant for extractive leaching of the column charge. As seen from Table 1, the flow of solvent to Column 4 was relatively low in comparison to the others. Solvent was applied at a constant rate to each column throughout the test, at the specified rate. The first effluent from Column 4 was very viscous, the drips in fact requiring several seconds to fully spread out after falling into a glass receiving vessel. By comparison, the effluent from Column 2 was noticeably less viscous. Even Column 1, with twice the bed height of the rest of the columns, had effluent of lower viscosity compared to Column 4. FIG. 8 represents gravimetric yield from the columns in Table 1. In Column 4, cumulative gravimetric recovery initially increased as a function of time, as evidenced by the data exhibited in FIG. 8. However, the plot for Column 4 also shows that after a period of time the rate of gravimetric recovery diminished and total recovery approached a terminal amount less than that of the other column tests. The failure of continued application of solvent, e.g., after 80 hours, to extract remaining compounds from Column 4 is evidence that a low solvent application rate is capable of terminally limited gravimetric recovery. This indicates that tarring is capable of resulting in loss of extractive recovery for at least the near-term, e.g. the period tested. FIG. 8 represents hexane extraction of dried algae in comparative column tests. Examples discussed later, and shown in FIGS. 11, 13 and 14, further illustrate results attributed to the “tarring” effect.

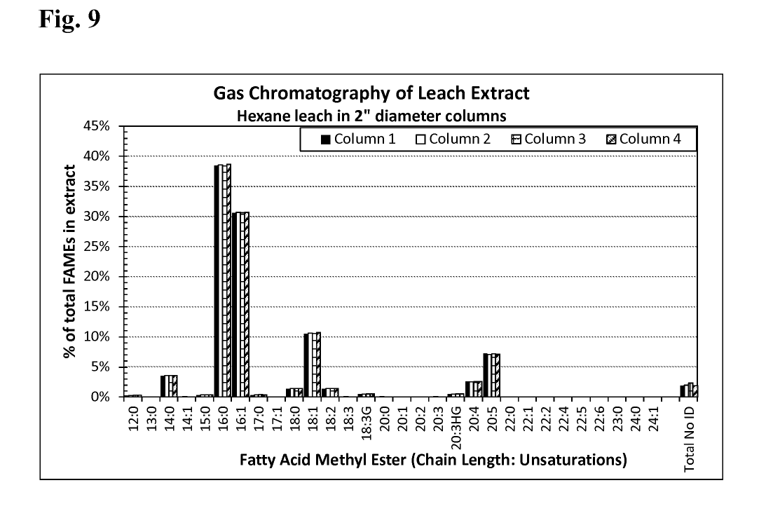

Besides the gravimetric yield from the samples, the chemical structure of the compounds recovered and their relative proportions in the extract at different leachant application rates are of interest. Accordingly, samples of the extracts from the 2″ (50 mm) diameter column tests, which used widely varying application rates, were subjected to transesterification and analysis by gas chromatography (GC). FIG. 9 shows the GC analytical results, with the columns labeled as per Table 1. These experiments demonstrated that there was no significant difference between the extract compositions from the hexane-leached columns, including the extract from Column 4, which as noted in the discussion of FIG. 8 exhibited evidence of tarring. FIG. 9 represents the gas chromatography analyses of the hexane extract from four of the column tests described in Table 1.

### Example 6

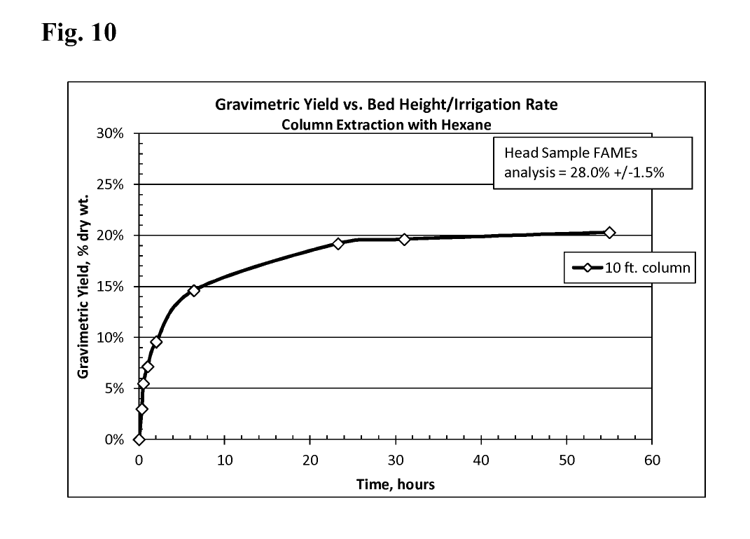

A subsequent column test was conducted using a 1″ (25 mm) diameter steel pipe which was 10 ft (3 m tall). This column was loaded with dried, crushed and agglomerated algae in the same manner as the 22″ (550 mm) tall columns. The final loaded charge was 998 g and 9.79 ft (2.98 m) tall. This taller column was leached at a high initial solvent flow rate of 20 mL/min, equivalent to 2150 L/m²/hr (35.8 L/m²/min) and 1.2 L/kg/hr, to assist in saturating the bed of dried algae and to reduce or prevent a tarring effect noted at low flows in the 2″ (50 mm) diameter column. The appearance of first effluent, known as “breakthrough”, occurred 16 minutes after initiating solvent flow. At 30 minutes after breakthrough, the solution application rate was decreased to 1.8 mL/min, a specific application rate of 194 L/m²/hr (3.2 L/m²/min) and 0.11 L/kg/hr. A plot of gravimetric yield, which is used as a measure of extraction of soluble compounds from algal mass, showed that when the solvent application rate was slowed the rate of leach recovery slowed significantly, as evidenced by the sudden decrease in the slope of the plot of gravimetric yield versus time. In fact, the leach rate of this column never returned to its previous rate of extraction and the column achieved a lower extent of gravimetric yield than previous leaching tests using the same composite feed sample. See FIGS. 10 and 11. Based on this test, it was decided a longer application of relatively high solvent flow rate may be needed for a tall fixed bed leach configuration to avoid, for example, a tarring effect. In part, due to the added contribution of successive layers of agglomerates in a tall leaching vessel to the attainment of equilibrium solute concentration in the percolating solvent leachant, a taller column may require a higher initial solvent application rate, or a longer application of a high initial rate, compared to a shorter column. One skilled in the art can see that testing and observation may be required to determine an appropriate initial high application rate, as well as the duration of same.

FIG. 10 represents leach extraction in a tall column at high application rate for a short duration. FIG. 11 represents data from FIG. 10 from the start of elution to 4.5 hours.

In another method, a GC analysis was conducted on samples of leachate collected from the 1″ (25 mm) dia. column in Example 6 during the course of leaching. This was performed to determine whether the extract composition of FAME chain length varied with time. Preferential leaching of compounds over time may permit preferential separation of compounds, but may also necessitate extra measures to maintain a consistent leachate composition, if desired. As represented in FIG. 12, essentially no variation of composition over the duration of the leach was noted for FAME chain length and bond location. FIG. 12 represents gas chromatography analyses of the hexane leach extracts at different leach times.

### Example 7

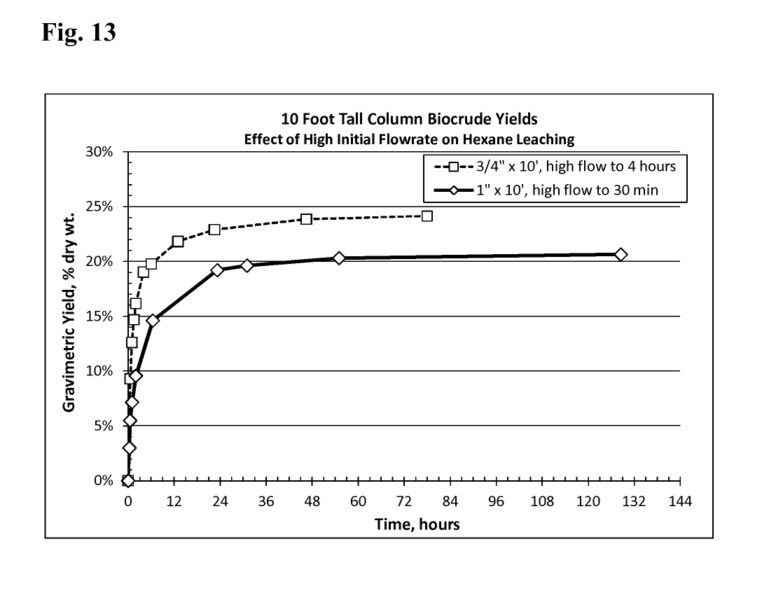

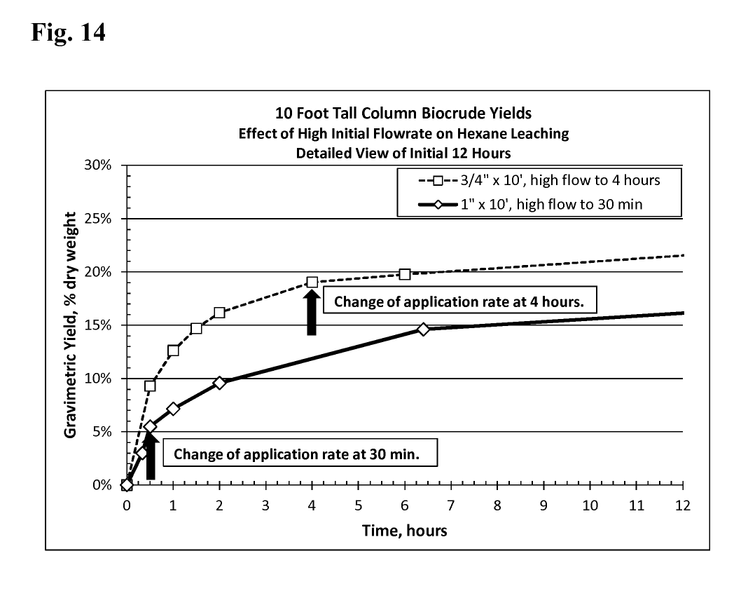

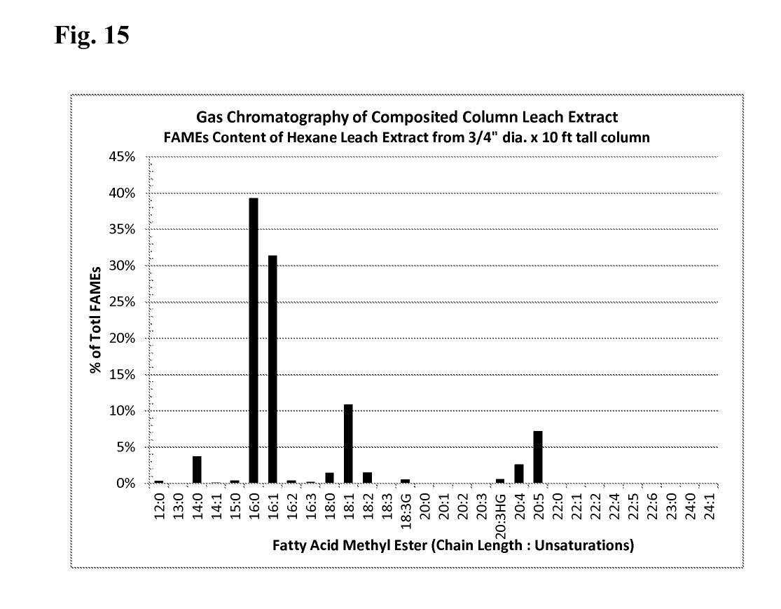

In another example, a second tall column, ¾″ (20 mm) diameter and 10 ft (3 m) tall, was set up using the same composite feed sample of dried and agglomerated algae. The loaded charge was 531 g and 8.54 ft (2.60 m) tall. In this test, a high initial application rate of 12.4 mL/min, equivalent to 2160 L/m²/hr and 1.4 L/kg/hr, was continued for 4 hours to avoid the tarring effect noted in the 1″ (50 mm) diameter column test in Example 6. Using the high initial rate application for a longer period, the effluent remained very fluid during this period. Over the high application rate period, the effluent color progressed from opaque to dark forest green, and at the end of 4 hours the leachate in the receiving container was noted to be able to pass a beam of bright light. Due to this change in opacity and therefore presumably concentration, the applied flow was decreased at 4 hours to 1.1 mL/min, equivalent to 191 L/m²/hr and 0.124 L/kg/hr. The gravimetric yield data, illustrated in FIGS. 13 and 14, demonstrate that the initial period of high flow was successful in faster extraction of compounds and that the plot of extraction as a function of time illustrates only a minimal extraction rate change when flow was decreased. The plot also demonstrates that the ultimate recovery achieved was higher than the 1″ (25 mm) diameter column, adding support to the proposition that a relatively lower application rate led to the inhibited leaching in the 1″ (25 mm) column and that the sustained higher application rate contributed to the greater terminal recovery in the ¾″ (20 mm) diameter column. In addition, the faster recovery of the sustained higher-application rate column represents a benefit in itself in that operating costs may be minimized in commercial operations by realizing faster recovery of the desirable components. FIG. 13 represents the leach extraction in two tall column tests as a function of time at the high flow application. FIG. 14 represents a detailed view of the initial 12 hours of leach extraction in the tall column tests. Hexane leachate collected from the ¾″ (20 mm) diameter column test, following measurement and sampling, was consolidated and distilled to remove the more-volatile hexane from the algal compounds in the extract. A sample of the final extract was analyzed, and the results are shown in FIG. 15. FIG. 15 represents a histogram plot of the gas chromatography analysis of the extract from the ¾″ (20 mm) diameter column leach.

In the column leaching tests of dried and agglomerated algae, an initial high rate of component recovery from the sample charge is followed by an increasingly slower rate as the recovery rate tapers off to a final level. The effective completion of solute leaching from the charge can be selected based on relative depletion of solute from the charge, or from a minimum solute concentration in the leachate.

Following the effective completion of leaching a “push” of compatible fluid can be applied to the column charge to assist in final draining of leachate from the column. For example, this push fluid to drain leachate from the column can utilize a gas, which when combined with the solvent vapor is non-combustible or otherwise non-reactive, e.g. nitrogen or carbon dioxide for flammable solvents. This push fluid assists in final recovery and removal of solvent from the bed and potentially any remaining compounds of interest. The push fluid, typically a gas, and solvent vapors are routed to an appropriate recovery and/or venting system. Such a system may consist of a condenser to recover the solvent, or at minimum a ventilation system to prevent solvent fumes from causing health and safety issues at the leach apparatus.

Once the recovery of the liquid solvent is complete, the receiver for the initial leachate can be disconnected from the leach charge container. Following the application of the push fluid, further inert gas can be applied to the column to dry the charge. This stage may be skipped if a sequential leachant is to be applied which is deemed compatible with the initial leachant, and mixing of the two leaching agents would not create undesirable consequences, e.g., difficult separation. Because the push fluid is transporting solvent from the column charge, it may be desirable to route the drying fluid through a condenser to recover the solvent, as well as prevent its release to the environment. Pre-heating the push and drying fluids, as well as heating of the column and column charge itself, could shorten drying times and improve extent of drying.

If desirable, for example, for the recovery of a different compound than extracted during the first leaching, a subsequent leach stage may be initiated with a different solvent. This can include the application of a non-polar solvent such as hexane for the initial leach recovery of predominantly non-polar lipids from algae, followed by the application of a polar solvent for recovery of polar compounds, or vice versa. This scheme for extraction is simplified by the use of the described fixed bed leach process, which provides high percolation rates through the agglomerated charge, thorough counter-current leaching of the charge, efficient draining of contained leachant, and the ability to apply a relatively high flow rate of push fluid at low differential pressure following the initial leach. As with the initial leachant, irrigation with a subsequent solvent can utilize varying application rates to optimize amount of solution applied, rate of solute extraction and concentration of leachate. The packed bed configuration, particularly with a high aspect ratio giving a consequently long flow path, permits a more practical and easily accomplished secondary leach. This simplified process can be compared to the application of a secondary leach in an agitated leaching process, in which the solids are removed from the agitation vessel, filtered with or without drying, and then added back to the agitation vessel in order to be re-suspended with the secondary leachant. When secondary leaching is complete, or has proceeded as far as practical, the solids are again removed from the agitation leach vessel and filtered with or without subsequent drying. As can be appreciated by one skilled in the art, the added process steps, equipment, handling and complexity required for secondary agitated leaching add effort and cost when compared to the packed bed configuration.

### Example 8

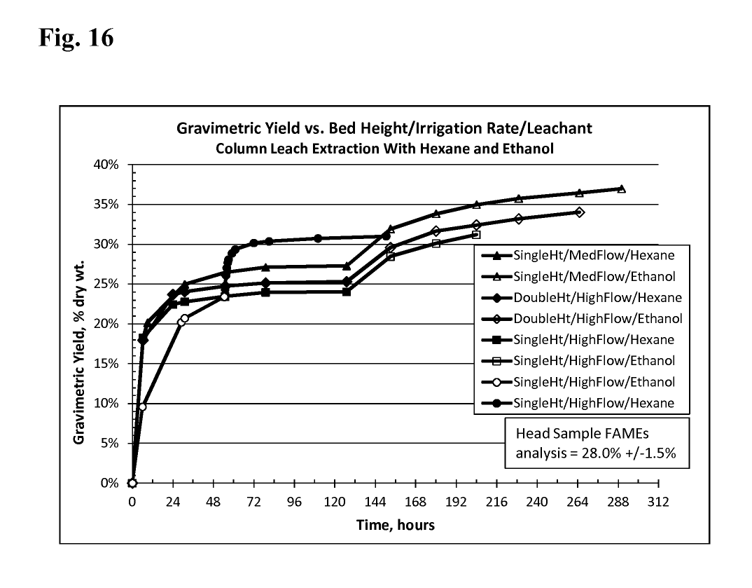

In one example, ethanol leaching was conducted after hexane leaching of the 2″ (50 mm) column tests described in Table 1. FIG. 16 represents a plot of secondary leaching with ethanol of dried and agglomerated algae. FIG. 16 represents a gravimetric recovery in columns where hexane was the first leachant and ethanol the secondary leachant for three columns, while ethanol was the first leachant and hexane the secondary leachant for another column. During primary ethanol column leaching of the Sngl/HighF low/Ethanol test, the ethanol leach was terminated early and, following an inert gas push and drying period, secondary leaching with hexane was initiated.

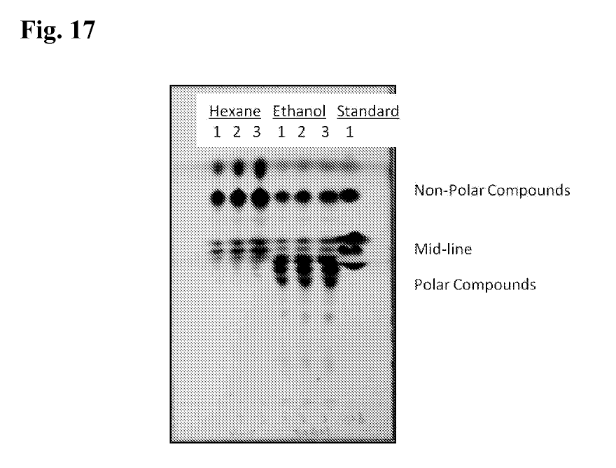

While conducting leach tests using primary and secondary leach solvents, it was found that there can be differences in the extraction rate, depending on the order of the solvent used for extraction. To analyze the general nature of the compounds being recovered, thin layer chromatography (TLC) was used on leach solutions and differences in composition were found. FIG. 17 is a photograph of a TLC plate of the algal leach solutions. The plate displays compounds extracted by a hexane, a non-polar solvent, on the left and ethanol, a polar solvent, in the middle leached in primary and secondary order, respectively, from the same algae column sample. The two leach solutions are evaluated against a standard solution on the right side of the plate. Three lanes are evaluated for each extract, labeled 1-3, with increasing amounts of leachate spotted to the plate with increasing lane number, e.g. Lane 3 hexane leachate was added more heavily than Lane 2 hexane, etc. Though polar solvent should not, in theory, extract non-polar compounds, some non-polar compounds do appear above the TLC mid-line from the ethanol leach extract. In contrast, very few polar compounds are found in the non-polar leach extracts on the left side of the figure. FIG. 17 represents thin layer chromatography of sequential polar and non-polar leach solutions.

Once recovery of the secondary solute or solutes has been achieved, a push fluid similar but not necessarily identical to the first push fluid, is applied to the charge to assist in final leachate recovery and column draining. After the push, the secondary solvent receiver is removed prior to the application of the drying fluid. The drying fluid is then applied until a desired extent of drying is achieved. After drying, the column charge can be removed. This may be accomplished by opening the bottom of the column, e.g. via a bolted flange or a hinged end cap or diversion chute, and allowing the charge to exit the column by force of gravity into a receiving vessel which can be a mobile transfer vessel or final container, e.g. a wheeled tray or a barrel. Depending on the character of the biomass being treated and the last solvent utilized, it may be desirable to utilize static charge dissipation or minimization measures during vessel unloading for safety purposes. Inert gas blanketing may also be utilized to reduce the potential for static ignition of residual solvent vapors which potentially may exist. From there the leach residue, also known as leached substrate, can be packaged for subsequent recovery of other desirable compounds, or for storage, subsequent treatment or disposal. The recovered leachate contains the applied solvent or solvents in combination with desirable components, e.g. algal lipids, leached from the charge. The primary and secondary leachates will most likely be treated separately to remove solvents from desirable compounds. One such recovery method is by distillation in the presence of vacuum, e.g. Rotovap distillation, or distillation without added vacuum. Following solvent removal, the remaining liquid or semi-solid material represents the extract residue, also known as extract or bio-crude. The extract residue can include, but is not limited to, algae oils, EPA, DHA and the like. Residues from distillation of non-polar and polar leachates may be combined if desired or kept separate, depending on the lipid compounds present and the end use of those compounds.

### Example 9

In another exemplary method, two stainless steel 12″ diameter×11′-4″ tall columns were constructed. The columns were heat-traced with electrical elements covered by insulation, and the solutions applied to each were piped through tubing passing through a steam-heated glycol bath to ensure controlled temperatures in the leach columns. Algae of the first commissioning column leach was dried at 100° C. This algae was ground in a hammer mill using a discharge screen of 2 mm dia. holes. The algae were agglomerated in 18 kg batches in a large, ⅓ cubic yard (0.25 cubic meter) fiberglas-lined cement mixer at 44% -48% by-mass added moisture (water only). The agglomerated algae were dried for approximately 48 hours. The column was loaded with 144 kg of re-dried algae. Solvent application rates were ratioed per column sectional area from the 1″ and ¾″ diameter by 10 feet tall columns, and 3.3 L/min or 2528 L/m²/hr during the initial high-flow period of 3 hours, and then 290 mL/min or 224 L/m²/hr for the remainder of the leaching cycle. It may be noted that ambient temperatures during this commission run were as low as −19° F. (−28° C.), with no effects on the extraction process. A total of 36.8 L or 33.3 kg of final extract were recovered, for 23.1% mass recovery to extract. The second commissioning leach run later the same month achieved 31.2% mass recovery to extract.

### Example 10

An alternate method of fixed bed processing using material which contains fines is to separate fines from more coarse particles and process these two size classifications separately. One example would be screening the charge material to establish two particle classifications, fines and coarse, and leach the coarse particles in a fixed bed, while either disposing of the fines or agitation leaching them.

One alternative method of attaching fines can be accomplished during drying. This method includes spray drying of an algal broth. Spray drying can create a porous agglomerated particle concurrently with moisture removal, but also can incorporate components of the growth media into the dried biomass, e.g. salts and/or metals, for example, in the case of marine algal cultures. In some cases, further drying may be necessary for thorough leach extraction. Alternatively, agglomeration and re-drying after initial spray-drying can be used for a more optimal condition, for example, to create larger particles with concomitantly larger pores which will pass solvent through the fixed bed. By providing attachment of fines, agglomeration can retain a significant majority of up to 70, 80, 90 or even 100 percent of fines from exiting the packed bed until completion of leaching. Thus, agglomeration is capable of achieving liquid-solid separation during the leach process instead of through additional processing, e.g. filtration after agitated leaching. Concurrent retention of fines during leaching can reduce processing costs, of both capital and operating cost components. The demonstrated ability to conduct sequential and separate leaching with various solvents, of agglomerated particles in fixed bed can provide an improved efficiency of process and increased extraction of desirable components of the feed material.

### Process Example A—Leach Finely Ground Algae in a Fixed Bed Without Agglomeration

In this exemplary method, particle size was analyzed for its affect on percolation and the ability to conduct solvent leaching of dried algae. Crushed and ground algae were loaded into a 3″ (76 mm) diameter glass column. Hexane solvent was added to the top of the algae charge. Shortly after the bed had become saturated with solvent, percolation came to an effective stop. Nitrogen was applied to the top of the column at 10 psig (69 kPa) but was unable to force useful amounts of solvent through the packed bed and the test was terminated.

### Process Example B—Separation of Fines From Larger Particles, Prior to Leaching

In this exemplary method, alternate leaching schemes where fines are separated from larger particles, e.g. screening of material to remove substantially all particles less than 300 micrometers in size, with packed bed leaching of the coarse particles were analyzed. Here additional processing was required and a loss from the process of approximately 20% of the sample mass was observed. The fines can be disposed of, or agitation leached but at increased cost compared to fixed bed leaching due to agitation and filtration costs. Further, to achieve counter-current contact for equivalent leaching to a fixed bed, this approach requires additional equipment for either counter-current decantation (or successive steps of filtration and repulping (resuspending) the algae, at increased cost and labor compared to fixed bed agglomerated leaching.

### Process Example C—Example of Liquid-To-Solid Ratio (“L/S Ratio”) Affecting Solvent Leach Recovery of Extractable Compounds

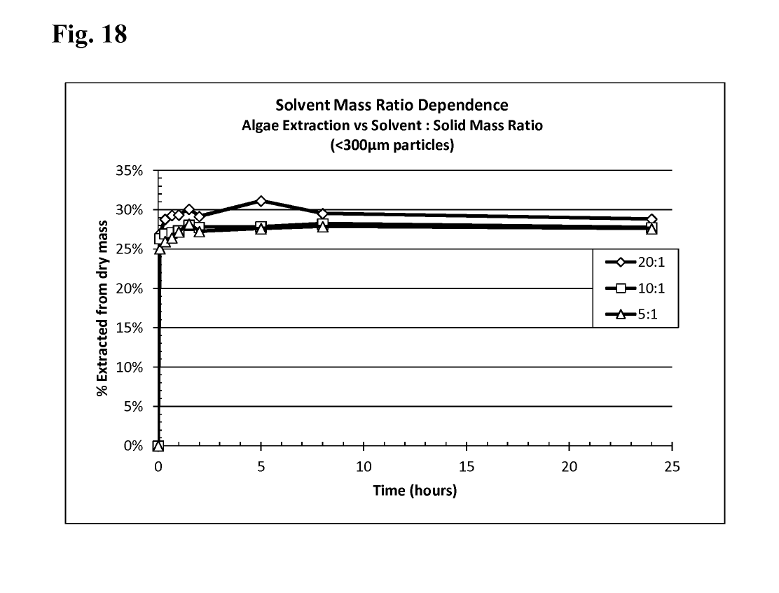

FIG. 18 illustrates the effect of L/S ratio on gravimetric yield from dry algae in agitated hexane leaching. Use of insufficient solvent during leaching can lead to early solvent saturation with solute and inhibited solute recovery or extended leach times. Use of excess solvent affects process economics, e.g. equipment sizing, cost of consumables, flammable liquid storage, cost for added distillation capacity, and distillation operating cost (energy input), among others. This test indicated minimal if any deleterious effects from use of a 5:1 L/S ratio as compared to 10:1 and 20:1 L/S ratios.

### Process Example D—Agglomeration Test Using Dried and Crushed Algae, to Produce Attachment of Fine Particles

A charge of Nannochloropsi spp. algae was dried at 100 degrees Celsius and crushed to reduce particle size, achieving particles 76% by weight less than 20 mesh/850 microns, including 23% less than 48 mesh/300 microns. This charge was agglomerated using successive moisture addition as coarse droplets sprayed onto a cascading algae charge in a rolling container. Moisture added during agglomeration was 36% water compared to dry weight of sample. After agglomeration, the charge was dried in a convection oven for just over 19 hours. Several individual agglomerates, also known as “prills”, were selected as representing approximately averaged sized agglomerated particles and submerged in a container of hexane as a test of prill stability. The prills were observed over a period of several hours and then days, with the condition noted as to how the compound particles held together in the presence of ubiquitous solvent. In this stability test, no fines were noted to detach from the prills.

### Process Example E

Column leach test using algae, demonstrating benefit of agglomeration on extraction and percolation of increased pore volume.

A sample of the material agglomerated in Example D was loaded into a column for leaching. The column and charge formed a packed bed ½ inch (12.7) mm diameter and 12 inches (305) mm deep. Weighing 20.5 grams, the settled agglomerates had a bulk density of 0.53 compared to water. A previous column test used a charge of dried and crushed algae of the same species (e.g. the charge that was screened to remove particles sized less than 48 mesh (300 microns)). This unagglomerated packed bed had a bulk density of 0.65, noticeably more dense, demonstrating that agglomerated particles produced a lower bulk density. The improved flow characteristics of the smaller column indicate the agglomerated bed also had a larger pore volume on a unit mass basis. The agglomerated column was leached with hexane dripped from a valved feed vessel onto a thin pad of glass wool placed in the column above the charge to distribute applied solution. For the majority of the test, solvent flow was maintained at approximately 1 milliliter per minute (mL/min), equivalent to 474 L/m²/hr. The leachate exited the charge by gravity flow from the bottom of the column and was collected in a receiver container. Following hexane leaching, a push of nitrogen gas was directed in downflow configuration through the column, which assisted in final draining of leachant. The column charge then dried in the nitrogen flow, gaining a light color throughout the column within one minute. Nitrogen flow was continued for approximately 3 minutes and then stopped.

For additional information regarding the algal residue with respect to hexane leaching, the charge was removed from the column leach apparatus for weighing. This step may be of value for scaling up etc. Then the charge was reloaded into the original column and settled by tapping. Some segregation due to the aforementioned handling and reloading was noted, and a particular region of finer but still agglomerated material accumulated in the middle one-third of the columnar bed. A small pad of glass wool was again placed over the charge. A polar solvent, 100% ethanol, was then applied in the same manner and flow rate as hexane had been initially. Leaching was continued until column effluent appeared light yellow in color. A final flush volume was applied and then the column was allowed to drain. Again, nitrogen was applied in downflow configuration as a push fluid, and continued thereafter to assist drying.

Distillation of the two leachate solutions was conducted separately to remove the solvents from the extracted constituents. The residue or extract demonstrated that 29.3% weight/weight (w/w) had been leached from the charge during hexane leaching, and 7.3% w/w was removed during ethanol leaching, for a total extraction of 36.6% w/w. This level of recovery was in contrast to agitation leach recovery tests which showed that grinding to 100% smaller than 48 mesh (300 micron) particle size was necessary to achieve 31% extraction in hexane leaching, roughly comparable to the non-polar, hexane leach recovery of the agglomerated fixed bed leach, but at much greater grinding effort and at added complexity and cost of agitated leaching. At production scale, reduction in particle size could lead to increased expense. The size reduction and L/S separation of finely ground and leached material can both be avoided by agglomerated fixed bed leaching.

### Process Example F

Algal solids, previously concentrated and frozen, were dried at 112° C. and then crushed and ground using a laboratory hammer mill. The hammer mill was equipped with a 0.079″ (2 mm) diameter round hole discharge screen, which produced a particle size distribution including 90% w/w passing 16 mesh (1 7 mm) and 17% passing 48 mesh (300 micron). This fine material was subjected to agglomeration tests, during which it was determined that 60% water addition produced a favorable agglomerate, so judged by complete attachment of fines and moderately-sized aggregates of well-consolidated particles, which possessed noticeable spaces between individual particles. The agglomerated material was subsequently dried at 112-113° C. in a convection oven. Columns were erected for leaching, and consisted of 2″ (50 mm) diameter by 2 ft (0.6 m) length glass columns (e.g. Reeves Glass Inc., Trenton, Fla., model RG3443-05). Each column included a Teflon discharge stopcock. For process development investigation into leaching parameters, the columns were operated in parallel and included two columns operated in series. Table 2 represents a summary of operating parameters selected for each test.

TABLE 2
Operating Parameters of Parallel and Series Columns

| Test No. | 1 | 2 | 3 | 4 | 5 |
|---|---|---|---|---|---|
| Bed Height, mode | High | Low | Low | Low | Low |
| Bed Height, m | 1.2 | 0.6 | 0.6 | 0.6 | 0.6 |
| Irrigation mode | High | High | Med | Low | High |
| Irrigation, L/hr | 0.21 | 0.21 | 0.072 | 0.03 | 0.21 |
| Leach mode | Hex- | Hex- | Hex- | Hex- | Eth- |
| | Eth | Eth | Eth | Eth | Hex |

Bed height notation in the Table refers to Low as being one column tall, approximately 2 ft (0.6 m), while High refers to two columns stacked over one another and leached in series, with the effluent of the top column feeding the bottom column, for total effective bed height of approximately 4 ft (1.2 m). Leach mode refers to order of solvent application, Hex-Eth indicating hexane followed by ethanol, Eth-Hex indicating the reverse order. Leach irrigation rates were selected based on calculated L/S mass ratios for an assumed duration, as shown in Table 3.

TABLE 3
Irrigation Rates Per Bed Height, L/S Ratios and Leach
Durations in 2″/50 mm Dia. Columns

| Conditions | L/hr | ml/min |
|---|---|---|
| 2 ft, 10 L/S, 2 days | 0.21 | 3.5 |
| 2 ft, 5 L/S, 3 days | 0.072 | 1.2 |
| 2 ft, 3 L/S, 4 days | 0.031 | 0.52 |

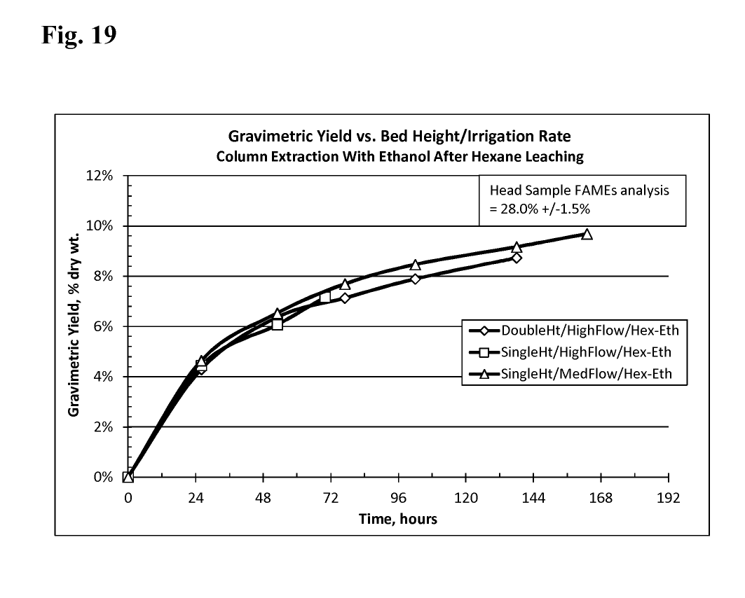

FIG. 19 represents gravimetric yield during secondary leaching of dried algae with ethanol of the columns in Process Example F.

### Process Example G

As a sub-test of Process Example F, after general leaching was complete, a flush of the column was performed to remove any previously solubilized compounds. Accordingly, a beaker of hexane was dumped onto a glass column measuring 2″(50) mm diameter, which contained a bed of agglomerated algae. The beaker held 300 ml of hexane, and was poured onto the algae in less than 3 seconds, for a specific application rate of 73 gal/ft²/min (2960 L/m²/min) Under close observance, the solution did not accumulate at the surface, e.g. no flooding of the column was noted. Instead, the solvent could be seen initially as a wetted front which was passed into the fixed bed and was quickly distributed into a percolating flow through the column.

### Process Example H

In some exemplary methods, a vertical spray dryer can be used to generate agglomerated cultures.

The FIG. 10.13 of Handbook of Industrial Drying appears to indicate that with a differential temperature (Air to Particle) of 500° C., a particle of up to 1 mm diameter is possible.

### Example 11

On possible increased oxidation of components of algae when spray-dried, (Beta-carotene studies in Spirulina, Flakes (about 20 mesh+) retained 52% of the original beta-carotene level while the spray-dried fine powder (100 mesh-), retained only 34% of the original level. This can be explained in terms of surface area available for active reaction which is higher in the powder than in flakes. This questions the suitability of using spray drying for Spirulina drying. Surface area available for active reaction is higher in the powder than in flakes.

### Example 12

Example of spray-dried algae:

Spray drying of algae can be used starting very fine particles. Algae slurry can then be conveyed in a pipe to a tank, for example, a 30″ BOWEN TOWER SPRAY DRYER, S/S (Stainless Steel). A sprayer dryer can be preheated to 106° F. The algae slurry can be dried in the spray dryer for about 2 minutes at a rate of about 1000 lbs per hour to produce a powdered composition with an average moisture content of about 8%. The particle size of the powdered composition ranged from about 80 microns to 300 microns.

Apparatus contemplated herein can include a device similar to a cement mixer or other similar device that is motorized, or partially motorized or human-powered. Coatings can be applied to the interior of the apparatus in order to reduce microorganisms and solvents from adhering to the surface.

All of the COMPOSITIONS and/or METHODS and/or APPARATUS disclosed and claimed herein can be made and executed without undue experimentation in light of the present disclosure. While the compositions and methods of this invention have been described in terms of preferred embodiments, it will be apparent to those of skill in the art that variation may be applied to the COMPOSITIONS and/or METHODS and/or APPARATUS and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for extracting target compounds from a biomass, the method comprising:
drying a biomass;
milling the dried biomass to create fines;
agglomerating the fines to create agglomerated particles; and
percolating a solvent through the agglomerated particles.

2. The method of claim 1, wherein percolating the solvent through the agglomerated particles includes applying the solvent in accordance with counter-current leach extraction.

3. The method of claim 1, wherein drying the biomass includes drying the microbial biomass at a temperature of 85° C. or greater to 148.5° C. or lower.

4. The method of claim 1, further comprising adjusting ambient pressure while agglomerating the fines in order to advance dehydration of the biomass.

5. The method of claim 1, further comprising exposing the agglomerated particle to a non-flammable solvent to create a non-flammable mixture.

6. The method of claim 1, further comprising drying the agglomerated particles at atmospheric pressure at a temperature ranging from 85 degrees Fahrenheit up to 150 degrees Fahrenheit.

7. The method of claim 1, further comprising drying the agglomerated particles at a pressure that is less than atmospheric, wherein drying the agglomerated particles at the pressure that is less than atmospheric includes lowering the temperature of the agglomerated particles.

8. The method of claim 1, wherein the biomass is derived from a suspension culture that includes one or more of the following: a microbial biomass of algae, bacteria, yeast, fungi, and other microorganism, suspended solids in water and wastewater particulates.

9. The method of claims 1, further comprising applying the agglomerated particles to a separation column with a high length-to-diameter ratio of 5:1 or greater to 30:1.

10. The method of claim 1, wherein the solvent is a first solvent that extracts a first target compound, and wherein the method further comprises introducing at least a second solvent to the column to extract a second target compound.

11. The method of claim 1, wherein agglomerating the fines to create agglomerated particles includes rotating the fines while applying an insoluble binding agent.

12. The method of claim 1, wherein agglomerating the particles includes adding only coarse water droplets to agglomerate the particles.

13. The method of claim 1, wherein percolating the solvent occurs at or below 35° C.

14. A prill composition formed of microbial biomass comprising:
a plurality of agglomerated fines that each retain a majority of their surface area and are less than 300 microns; and
a neutral substrate.

15. The prill composition of claim 14, wherein the agglomerated fines include an insoluble binding agent.

16. The prill composition of claim 14, wherein the plurality of agglomerated fines form agglomerated particles each about 300 microns or greater, and wherein the agglomerated particles comprise 50 percent or more of the prill.

17. The prill composition of claim 14, wherein the plurality of agglomerated fines form agglomerated particles each about 300 microns or greater, and wherein the agglomerated particles comprise 80 percent or more of the prill.

18. A method for generating a prill comprising:
obtaining a microbial biomass from a suspension culture;
drying the microbial biomass until the biomass is at least 90% dry mass;
milling the dry microbial biomass to create particles; and
agglomerating the particles to generate agglomerated particles of 300 microns or greater while retaining a majority of the surface area of the particles to form the microbial prill.

19. The prill of claim 18, wherein the step of agglomerating the particles occurs at a sub-atmospheric pressure.

20. The prill of claim 8, wherein the step of agglomerating the particles includes using a polymeric binder.

21. A method for agglomerating dried and ground biomass from a suspension culture comprising, rolling at least partially dried biomass in an apparatus with a neutral substrate, optionally, wherein the a neutral substrate is administered to the biomass drop wise, and forming a clot or clump of biomass particles and thus agglomerating the biomass to form agglomerated particles.

22. The method of claim 21, further comprising, exposing the at least partially dried and ground biomass before, during or after agglomeration to at least one of the following sources of heat, air, light, microwave, visible light, infrared, other electromagnetic radiation or other energy source wherein the at least partially dried and ground biomass are further dehydrated by the at least one source.

23. The method of claim 21, further comprising adjusting ambient pressure while agglomerating the dried and ground biomass in order to advance dehydration of the biomass.

24. The method of claims 21, wherein the cultures are exposed to a gas and optionally, wherein the gas is a non-flammable gas; and wherein the agglomerated particles form a non-flammable mixture with the gas.

25. The method of claims 21, wherein the agglomerated particles are further exposed to a solvent and products of the agglomerated particles are extracted.

26. The method of claim 25, wherein the product is lipids.

27. The method of claim 25, wherein the product is a fuel or feedstock to produce fuel.

28. The method of claim 22, wherein pressure is atmospheric and temperature is 85 degrees Fahrenheit or greater but less than 150 degrees Fahrenheit.

29. The method of claim 22, wherein the cultures are spray-dried.

30. The method of claim 21, wherein the suspension culture comprises algae, bacteria, yeast, fungi, suspended solids in water or wastewater particulates.

31. The method of claims 21, further comprising a binding agent.

32. The method of claim 31, wherein the binding agents comprise corn starch, alginates, glucose, sucrose, fructose or other sugars, lignins and carbohydrates

33. The method of claims 21, wherein the agglomerated particles are applied to a separation column with a high length-to-diameter ratio.

34. A process for extracting one or more target compounds from biomass from a suspension culture, comprising applying agglomerated particles to a separation device and extracting a target compound from the agglomerated suspension culture.

35. The process of claim 34, wherein a first agent or solvent is introduced to the column to extract a target compound, and sometime later at least a second agent or solvent is introduced to the column to extract a second target compound.

36. The process of claim 35, wherein the agents comprise hexane, ethanol, chloroform or other solvents or polar agents.

37. An apparatus for agglomerating a suspension culture comprising a vessel capable of receiving water or other agent, the vessel capable of moving in at least one direction and a support or housing device attached to the vessel to permit moving from one location to another.

37. A device for assessing compressive strength of an algal prill comprising an agglomerate test device as depicted in FIGS. 6A-6E having at least one retention screen layer and a drain wherein the device is capable of assessing compressive strength of the algal prill.

38. A kit comprising
a prill composition of microbial biomass comprising:
a plurality of agglomerated particles of the microbial biomass wherein about 50 percent or more of the agglomerated particles are about 300 microns or greater, and a neutral substrate.

39. The kit of claim 38, further comprising one or more solvents.
